(19) United States
(12) Patent Application Publication
(10) Pub. No.: US 2025/0080959 A1
(43) Pub. Date: Mar. 6, 2025

(54) SENSING IN A WIRELESS COMMUNICATION SYSTEM

(71) Applicant: Nokia Technologies Oy, Espoo (FI)

(72) Inventors: Apostolos KOUSARIDAS, Munich (DE); Hideaki TAKAHASHI, Tokyo (JP); Pallab GUPTA, Bangalore (IN); Shubhranshu SINGH, Munich (DE); André NOLL BARRETO, Massy (FR)

(21) Appl. No.: 18/818,690

(22) Filed: Aug. 29, 2024

(30) Foreign Application Priority Data
Sep. 1, 2023 (GB) 2313320.0

(51) Int. Cl. H04W 4/38; H04W 48/20; H04W 76/10

(52) U.S. Cl. CPC H04W 4/38; H04W 48/20; H04W 76/10

(57) ABSTRACT

A method, apparatus and computer program is described comprising: receiving, from a sensing client of a wireless communication system, a sensing service request including information related to a sensing service, requested by the sensing client, to be provided by the sensing management function; selecting, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing.

### CROSS-REFERENCE TO RELATED APPLICATIONS

This application claims the benefit of priority of United Kingdom Application No. 2313320.0 filed Sep. 1, 2023, which is hereby incorporated by reference.

### FIELD

The present specification relates to sensing in a wireless communication system.

### BACKGROUND

The present specification relates to sensing in a wireless communication system, for example to obtaining awareness of a scene surrounding a sensing device. Example applications include detection or tracking of objects and extracting features for recognition or classification purposes. There remains a need for further developments in this field.

### SUMMARY

In a first aspect, this specification describes an apparatus (e.g. a sensing management function (SeMF)) comprising: at least one processor; and at least one memory storing instructions of a sensing management function, wherein execution of the instructions causes the apparatus to perform at least: receiving, from a sensing client (such as a UE, an application function (AF) or a network function (NEF)) of a wireless communication system), a sensing service request including information related to a sensing service, requested by the sensing client, to be provided by the sensing management function (the sensing service request may include information such as sensing QoS, sensing type, sensing requirements (e.g. sensing area) etc.); selecting, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing; based on monostatic sensing being selected: sending, to the first selected radio access network node used for transmission and reception of radio signals used for sensing, a sensing configuration for the first selected radio access network node; and based on multi-static sensing being selected: sending, to the one selected radio access network node used for transmission of radio signals used for sensing, a sensing configuration for the one selected radio access network node. Multi-static sensing encompasses bi-static sensing (e.g., including one transmitter and one receiver)

In some examples of the first aspect, the sensing configuration for the first selected radio access network node used for transmission and reception of radio signals used for sensing comprises at least one of a sensing resource configuration, a sensing session configuration, and a sensing data reporting configuration. Thus, the apparatus may configure mono-static sensing.

In some examples of the first aspect, the sensing configuration for the one selected radio access network node used for transmission of radio signals for sensing comprises at least one of a sensing resource configuration, a sensing session configuration, and a sensing data reporting configuration. Thus, the apparatus may configure multi-static (e.g., bi-static) sensing.

Based on multi-static sensing being selected, in some examples of the first aspect execution of the instructions may further cause the apparatus to perform at least: sending, to each respective other radio access network nodes used for reception (e.g. the second node of the bi-static case) of radio signals, a sensing configuration for the respective other radio access network node. In some examples of the first aspect, the sensing configuration for each respective other radio access network node comprises at least one of a sensing resource configuration, a sensing session configuration, and a sensing data reporting configuration.

In some examples of the first aspect, the information related to said sensing service may comprise at least one of: a sensing service type for the sensing service; sensing requirements for the sensing service; and sensing quality of service for the sensing service. The sensing requirements for the sensing service may, for example, include a sensing area for the sensing service.

In some examples of the first aspect, sending the sensing configuration for the first selected radio access network node (e.g., in the mono-static case) comprises sending, to the first selected radio access network node, a request to establish a sensing session for the sensing service that includes the sensing configuration for the first selected radio access network node.

In some examples of the first aspect, execution of the instructions may further cause the apparatus to perform at least: sending, to the first selected radio access network node (e.g. in the mono-static case) used for transmission and reception of radio signals for sensing, a request for the radio access network node to initiate sensing.

In some examples of the first aspect, execution of the instructions may further causes the apparatus to perform at least one of: receiving sensing data from the first selected radio access network node used for transmission and reception of radio signals for sensing; and receiving sensing data from the one or more other selected radio access network nodes (e.g. in the multi-static case) used for reception of radio signals used for sensing. Moreover, in some examples of the first aspect, execution of the instructions may further cause the apparatus to perform processing (e.g. at an SeMF) the sensing data to generate sensing output data; and providing the sensing output data (e.g. to the sensing client).

In some examples of the first aspect, sending the sensing configuration for the one selected radio access network node (e.g., in the multi-static case) comprises sending, to the one selected radio access network node, a request to establish a sensing session for the sensing service that includes the sensing configuration for the one selected radio access network node. In some examples of the first aspect, the request may further include an indication that the one selected radio access network nodes initiate sensing.

In some examples of the first aspect, execution of the instructions further causes the apparatus to perform at least: controlling session admission in which a determination is made regarding whether respective selected network node(s) are able to meet the defined requirements. The said requirements may relate, for example, to available resources and/or the ability to meeting quality of service (QoS) requirements.

In a second aspect, this specification describes an apparatus (e.g. a RAN node) comprising: at least one processor; and at least one memory storing instructions, wherein execution of the instructions causes the apparatus to perform at least: receiving a sensing configuration (e.g. comprising at least one of: a sensing resource configuration; a sensing session configuration; and a sensing data reporting configuration) for a sensing service at a radio access network node of a wireless communication system from a sensing management function of the wireless communication system, wherein the sensing configuration configures at least one of monostatic sensing for the sensing service, in which the radio access network node is a first selected radio access network node used for transmission and reception of radio signals used for sensing, and multi-static sensing, in which the radio access network node is one selected radio access network node used for transmission of radio signals for sensing or one of one or more other selected radio access nodes used for reception of radio signals used for sensing; configuring the radio access node in accordance with said sensing configuration; and causing the radio access network node to initiate sensing.

In some examples of the second aspect, execution of the instructions further causes the apparatus to perform at least one of: transmission of radio signals for sensing; and reception of radio signals for sensing.

In some examples of the second aspect, execution of the instructions may further cause the apparatus to perform at least one of: providing received radio signals to the sensing management function; and processing received radio signals and providing the processed received radio signals to the sensing management function.

In some examples of the second aspect, execution of the instructions may further cause the apparatus to perform at least: receiving a request for the radio access network node to initiate sensing.

In some examples of the second aspect, execution of the instructions may further cause the apparatus to perform controlling session admission in which a determination is made regarding whether sufficient resources are available to meet the sensing requirements included in the session establishment messages.

In some examples of the second aspect, execution of the instructions may further cause the apparatus to perform: providing a sensing session establishment response which may include an indication of acceptance of the request to establish a sensing session, an indication of rejection of the request to establish a sensing session, a “new and/or update sensing configuration for the sensing session, and/or an indication of resources allowed for the sensing session) in response to a request to establish a sensing session.

In some examples of the second aspect, execution of the instructions may further cause the apparatus to perform sending information about an updated sensing configuration.

In some examples of the second aspect, the transmitting RAN entity can identify and/or discover the receiver RAN entity and then have the inter RAN entity interaction discussed above.

In a third aspect, this specification describes a method comprising: receiving, from a sensing client of a wireless communication system, a sensing service request including information related to a sensing service, requested by the sensing client (such as a UE, an application function (AF) or a network function (NEF)) of a wireless communication system), to be provided by the sensing management function; selecting, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing; based on monostatic sensing being selected: sending, to the first selected radio access network node used for transmission and reception of radio signals used for sensing, a sensing configuration for the first selected radio access network node; and based on multi-static sensing being selected: sending, to the one selected radio access network node used for transmission of radio signals used for sensing, a sensing configuration for the one selected radio access network node. The method may, for example, be implemented at a sensing management function (SeMF).

In some examples of the third aspect, the sensing configuration for the first selected radio access network node used for transmission and reception of radio signals used for sensing may comprise at least one of a sensing resource configuration, a sensing session configuration, and a sensing data reporting configuration. Thus, the apparatus may configure mono-static sensing.

In some examples of the third aspect the sensing configuration for the one selected radio access network node used for transmission of radio signals for sensing may comprise at least one of a sensing resource configuration, a sensing session configuration, and a sensing data reporting configuration. Thus, the apparatus may configure multi-static (e.g., bi-static) sensing.

Based on multi-static sensing being selected, in some examples of the third aspect, the method may comprise sending, to each respective other radio access network nodes used for reception (e.g., the second node of the bi-static case) of radio signals, a sensing configuration for the respective other radio access network node.

In some examples of the third aspect, sending the sensing configuration for the first selected radio access network node (e.g., in the mono-static case) comprises sending, to the first selected radio access network node, a request to establish a sensing session for the sensing service that includes the sensing configuration for the first selected radio access network node.

In some examples of the third aspect, the method may comprise sending, to the first selected radio access network node (e.g., in the mono-static case) used for transmission and reception of radio signals for sensing, a request for the radio access network node to initiate sensing.

In some examples of the third aspect, the method may further comprise receiving sensing data from the first selected radio access network node used for transmission and reception of radio signals for sending and receiving sensing data from the one or more other selected radio access network nodes (e.g., in the multi-static case) used for reception of radio signals used for sensing. Moreover, the method may comprise processing (e.g., at an SeMF) the sensing data to generate sensing output data; and providing the sensing output data (e.g., to the sensing client).

In some examples of the third aspect, sending the sensing configuration for the one selected radio access network node (e.g., in the case multi-static sensing method is determined) comprises sending, to the one selected radio access network node, a request to establish a sensing session for the sensing service that includes the sensing configuration for the one selected radio access network node. The request may further include an indication that the one selected radio access network nodes initiate sensing.

In some examples of the third aspect, the method may comprise controlling session admission in which a determination is made regarding whether respective selected network node(s) are able to meet the defined requirements.

In a fourth aspect, this specification describes a method comprising: receiving a sensing configuration for a sensing service at a radio access network node of a wireless communication system from a sensing management function of the wireless communication system, wherein the sensing configuration (e.g. comprising at least one of: a sensing resource configuration; a sensing session configuration; and a sensing data reporting configuration) configures one of monostatic sensing for the sensing service, in which the radio access network node is a first selected radio access network node used for transmission and reception of radio signals used for sensing, and multi-static sensing, in which the radio access network node is one selected radio access network node used for transmission of radio signals for sensing or one of one or more other selected radio access nodes used for reception of radio signals used for sensing; configuring the radio access node in accordance with said sensing configuration; and causing the radio access network node to initiate sensing. The method may, for example, be implemented at a RAN node.

In some examples of the fourth aspect, the method may further comprise transmission of radio signals for sensing and reception of radio signals for sensing.

In some examples of the fourth aspect, the method may further comprise providing received radio signals to the sensing management function and processing received radio signals and providing the processed received radio signals to the sensing management function.

In some examples of the fourth aspect, the method may further comprise receiving a request for the radio access network node to initiate sensing.

In some examples of the fourth aspect, the method may further comprise controlling session admission in which a determination is made regarding whether sufficient resources are available to meet the sensing requirements included in the session establishment messages.

In some examples of the fourth aspect, the method may further comprise providing a sensing session establishment response in response to a request to establish a sensing session. The sensing session establishment response may include an indication of acceptance of the request to establish a sensing session, an indication of rejection of the request to establish a sensing session, an indication that a new and/or updated sensing configuration is required, or information indicating resources allowed for the sensing session.

In some examples of the fourth aspect, the method may further comprise sending information about an updated sensing configuration.

In some examples of the fourth aspect, the method may further comprise exchanging configuration and data between different radio access network nodes configured by the sensing management function for use during multi-static sensing.

In some examples of the fourth aspect, the transmitting base station can identify/discover the receiver base station and then have the inter-base station interaction discussed above.

In a fifth aspect, this specification describes computer-readable instructions which, when executed by a computing apparatus, cause the computing apparatus to perform (at least) any method as described herein (including the methods of the third or fourth aspects described above).

In a sixth aspect, this specification describes a computer-readable medium (such as a non-transitory computer-readable medium) comprising program instructions stored thereon for performing (at least) any method as described herein (including the methods of the third or fourth aspects described above).

In a seventh aspect, this specification describes an apparatus comprising: at least one processor; and at least one memory including computer program code which, when executed by the at least one processor, causes the apparatus to perform (at least) any method as described herein (including the methods of the third or fourth aspects described above).

In an eighth aspect, this specification describes an apparatus comprising: at least one processor; and at least one memory storing instructions that, when executed by the at least one processor, causes the apparatus to perform (at least) any method as described herein (including the methods of the third or fourth aspects described above).

In a ninth aspect, this specification describes a computer program comprising instructions which, when executed by an apparatus, cause the apparatus to: receive, from a sensing client of a wireless communication system, a sensing service request including information related to a sensing service, requested by the sensing client, to be provided by the sensing management function; select, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing; based on monostatic sensing being selected: sending, to the first selected radio access network node used for transmission and reception of radio signals used for sensing, a sensing configuration for the first selected radio access network node; and based on multi-static sensing being selected: sending, to the one selected radio access network node used for transmission of radio signals used for sensing, a sensing configuration for the one selected radio access network node.

In a tenth aspect, this specification describes a computer program comprising instructions which, when executed by an apparatus, cause the apparatus to: receive a sensing configuration for a sensing service at a radio access network node of a wireless communication system from a sensing management function of the wireless communication system, wherein the sensing configuration configures one of monostatic sensing for the sensing service, in which the radio access network node is a first selected radio access network node used for transmission and reception of radio signals used for sensing, and multi-static sensing, in which the radio access network node is one selected radio access network node used for transmission of radio signals for sensing or one of one or more other selected radio access nodes used for reception of radio signals used for sensing; configure the radio access node in accordance with said sensing configuration; and cause the radio access network node to initiate sensing.

In an eleventh aspect, this specification describes an input of a SEMF module (or some other means) for receiving, from a sensing client of a wireless communication system, a sensing service request including information related to a sensing service, requested by the sensing client, to be provided by the sensing management function; a control module (or some other means) for selecting, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing; an output of the SEMF module (or some other means) for, based on monostatic sensing being selected, sending, to the first selected radio access network node used for transmission and reception of radio signals used for sensing, a sensing configuration for the first selected radio access network node; and based on multi-static sensing being selected: the output of the SEMF module (or some other means) for sending, to the one selected radio access network node used for transmission of radio signals used for sensing, a sensing configuration for the one selected radio access network node.

In a twelfth aspect, this specification describes an input of a RAN module (or some other means) for receiving a sensing configuration for a sensing service at a radio access network node of a wireless communication system from a sensing management function of the wireless communication system, wherein the sensing configuration configures one of monostatic sensing for the sensing service, in which the radio access network node is a first selected radio access network node used for transmission and reception of radio signals used for sensing, and multi-static sensing, in which the radio access network node is one selected radio access network node used for transmission of radio signals for sensing or one of one or more other selected radio access nodes used for reception of radio signals used for sensing; a control module (or some other means) for configuring the radio access node in accordance with said sensing configuration; and the control module (or some other means) for causing the radio access network node to initiate sensing.

### BRIEF DESCRIPTION OF THE DRAWINGS

Example embodiments will now be described, by way of non-limiting examples, with reference to the following schematic drawings, in which:

FIG. 1 is a block diagram showing a monostatic sensing system in accordance with an example embodiment;

FIG. 2 is a block diagram showing a bistatic sensing system in accordance with an example embodiment;

FIG. 3 is a block diagram showing a system in accordance with an example embodiment;

FIGS. 4 to 7 are flowcharts showing methods or processes in accordance with example embodiments;

FIGS. 8 to 12 show message flow sequences and operations for procedures in accordance with example embodiments;

FIG. 13 is a schematic diagram of components of one or more of the example embodiments described previously; and

FIG. 14 shows tangible media for storing computer-readable code which when run by a computer may perform methods according to example embodiments described herein.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

The present specification relates to sensing in a wireless communication system, for example to obtain awareness of a scene that surrounds radio access network entities that are configured as sensing devices. This may, for example, include the capability to perform one or more of the following:
detection, localization and/or tracking of objects;
forming images of a specific scene or environment; and/or
identifying features of discovered objects for recognition and/or classification, etc.

A wireless communication system in which sensing and communication are integrated is generally referred to as an integrated sensing and communication system. An integrated sensing and communication (ISAC) system as described herein may potentially achieve both relatively high-data rate communications and relatively high-resolution object detection using at least some of the same hardware and spectrum resources. This may be advantageous, for example, in improving sensing accuracy for scenarios or situations where existing sensing techniques may not perform well (e.g. non-line-of-sight (NLOS) conditions, requirement for high velocity resolution etc), to enhance spectrum efficiency by sharing communication and sensing spectrum band, and/or to reduce hardware cost by combining sensing and communication equipment/hardware.

Example scenarios in which an integrated sensing and communication (ISAC) system could be used include (but are not limited to) the following:
Intrusion detection (e.g., intruder detection in a smart home, pedestrian or animal intrusion detection on a highway etc.)
Support for autonomous driving (e.g., sensing assisted automotive manoeuvring and navigation by providing additional information for detected objects on the roads such as pedestrians, bicycles, other vehicles etc, sensing for parking space determination etc.)
Support for unmanned aerial vehicle (UAV) flight (e.g., UAV flight trajectory tracing, network assisted sensing to avoid UAV collision by providing information for detected objects on the air especially those that may not have communication means to indicate their presence)
Support for automated guided vehicle (AGV) or autonomous mobile robots (AMR) in factories (e.g., AGV detection and tracking in factories), AMR collision avoidance in smart factories etc.)
Environment and/or weather monitoring (e.g., rain, pollution, flooding)
Health monitoring (e.g., fall detection, contactless sleep monitoring service)
Extended reality (XR) applications.

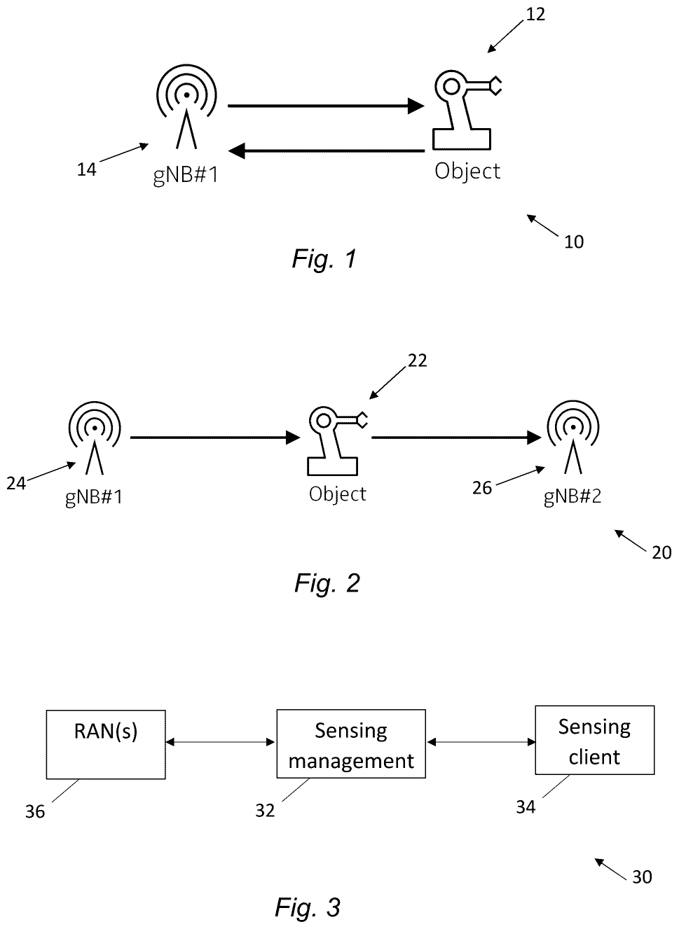

FIG. 1 is a block diagram showing a monostatic sensing system for a wireless communication system, indicated generally by the reference numeral 10, in accordance with an example embodiment. The monostatic sensing system 10 comprises a first radio access network entity 14 (a gNB in the example shown). The first radio access network entity 14 sends out (e.g., transmits) sensing signals (e.g., RF signals) when the first radio access network entity 14 is configured for a sensing operation (e.g., a monostatic sensing operation). Therefore, the first radio access network entity 14, when configured for a monostatic sensing is considered to be (or is acting as) a sensing transmitter. The first radio access network entity 14 also receives sensing signals (e.g., radio signals) that are, for example, deflected, reflected, or refracted by objects (e.g., object 12) in a vicinity of the first radio access network entity 14 when the first radio access network entity 14 is configured for a sensing operation (e.g., a monostatic sensing operation). Therefore, the first radio access network entity 14, when configured for a monostatic sensing operation is also considered to be or is acting as a sensing receiver.

FIG. 2 is a block diagram showing a bistatic sensing system for a wireless communication system, indicated generally by the reference numeral 20, in accordance with an example embodiment. The sensing system 20 comprises a first radio access network entity 24 (a gNB in the example shown) and a second radio access network node 26 (also a gNB in the example shown). The first radio access entity 24 sends out sensing signals (e.g., radio signals), when configured for a sensing operation (e.g., a bistatic sensing operation). Therefore, the first radio access network entity 26, when configured for a bistatic sensing operation, is thereby configured to be or is considered to be acting as a sensing transmitter). The second radio access network entity 26 receives sensing signals deflected, reflected or refracted by objects (e.g., object 22) located in a vicinity of the second radio access network entity 26 when the second radio access network entity is configured for a sensing operation (e.g., a bistatic sensing operation). Therefore, the second radio access network entity 26 is configured to be, or is considered to be acting as a sensing receiver) when the second radio access network entity 26 is configured for a bistatic sensing operation.

In the sensing system 10, the first radio access network entity 14 receives sensing signals (e.g., radio signals) that are, for example, deflected, reflected, or refracted by objects (such as object 12). Similarly, in the sensing system 20, the second radio access network entity 26 receives sensing signals. In the sensing systems 10 and 20, sensing measurement data (or sensing data/sensing measurement information) include data derived from sensing signals (e.g., radio signals) impacted (e.g. reflected, refracted, diffracted) by an object in an environment of interest when performing a sensing operation (e.g. the objects 12 or 22), and optionally processed (e.g. by a network function within a wireless communication system, such as a 5G and/or 6G system, a server external to the wireless communication system, application server connected to the wireless communication system via, for example, a network exposure function of the wireless communication system, edge server (e.g., a server located near the wireless communication server), etc.). While sensing output(s) includes processed sensing data e.g., requested by a sensing service consumer (or sensing service client) of a sensing service provided by the 5G and/or 6G system that includes the sensing system 10 and/or the sensing system 20.

Examples of sensing data or sensing measurement information comprise one or more of information about received or arrived electromagnetic signals. Information about a received or arrived electromagnetic signal may include a received power, delay, angle of departure, angle of arrival, doppler shift, and/or the like of the received or arrived electromagnetic signal.

The systems 10 and 20 therefore differ in that in the monostatic sensing system 10, the first radio access node 14 is configured to be or to act as both the sensing transmitter and the sensing receiver and in the bistatic sensing system 20, different radio access network nodes are configured to be or to act as sensing transmitters and receivers. Note also that the bistatic sensing system 20 is a special case of a multi-static sensing system in which one radio access network entity is configured to be or to act as a sensing transmitter and a plurality of radio access network entities are configured to be or act as sensing receivers.

In the monostatic sensing system 10 and the bistatic sensing system 20, the sensing transmitters and receivers are both radio access network entities (e.g., BSs, gNBs); this is not essential to all example embodiments.

Sensing operations for a sensing session performed by radio access network entities as described herein can be used in the context of a Public Land Mobile Network (PLMN) comprising a communication system comprising radio access network nodes as well as in the context of a Standalone Non-Public Network (SNPM) comprising a communication system comprising radio access network nodes.

FIG. 3 is a block diagram showing a wireless communication system, indicated generally by the reference numeral 30, in accordance with an example embodiment which supports or provides sensing services. The wireless communication system 30 comprises a sensing management module 32 that implements or comprises a sensing management function (SeMF) for providing sensing services to a sensing service client 34. and one or more entities 36 of a radio access network (generally referred to as a RAN entity 36 and collectively as RAN entities 36). As discussed further below, the sensing client 34 may be a user device (e.g., a UE), an application function (AF) or a network exposure function (NEF) of the wireless communication system (e.g., a 5G or similar system).

The sensing management module 32 is provided to configure, coordinate and enable the one or more RAN entities 36 for a sensing operation. The sensing management module 32 may be, may implement, or may comprise a Sensing Management Function (SeMF) as discussed in detail below.

As used herein, the term “sensing management module” refers to a combination hardware processing circuit and software and/or firmware comprising machine-readable instructions that are executable by the hardware processing circuit, or software comprising machine-readable instructions that are executable by a hardware processing circuit of an apparatus. A hardware processing circuit includes at least one processor comprising machine-readable instructions that are executable by the hardware processing circuit and at least one memory storing the machine-readable instructions. A processor may include any or some combination of an accelerator, microprocessor, a core of a multi-core microprocessor, a microcontroller, a programmable integrated circuit, a programmable gate array, a digital signal processor, a central processing unit, a graphic processing unit, a tensor processing unit. Memory may include any or some combination of volatile or non-volatile memory (e.g., a flash memory, cache, a random-access memory (RAM), and/or a read-only memory (ROM)). The memory 112 may store the machine-executable instructions of the software and/or firmware for execution by the at least one processor of the hardware processing circuit. The software and/or firmware may implement or comprise the SeMF, and the machine-executable instructions may be executed by the hardware processing circuit to perform the actions or operations of the methods of the SeMF described herein.

The SeMF implemented or comprised in the sensing management module 32 may receive, from the sensing client 34, sensing requests for different types of sensing services provided by the SeMF, determine a sensing method to be performed (e.g. whether a monostatic or multistatic (e.g. bistatic) sensing is to be used), determine one or more RAN entities 36 to be involved in a sensing operation based on the sensing method that is determined, and the sensing roles of the respective RAN entities. For example, for each of the one or more RAN entities, the SeMF implemented or comprised in the sensing management module 32 may determine sensing configurations including: sensing resources configurations; sensing session configurations (e.g., RAN entity that transmits sensing signals (sensing transmitter (Tx role) and/or RAN entity (or RAN entities) that receive the respective sensing signals (sensing receiver (Rx) role)); and sensing data reporting configurations.

The SeMF implemented or comprised in the sensing management module 32 interacts with the one or more RAN entities 36 and transmits to the one or more RAN entities 36 (e.g., during a sensing session establishment process to establish a session for the sensing service, generally referred to herein as a sensing session) the determined sensing configurations.

The SeMF may be configured to determine or calculate the sensing output as requested. A sensing output may comprise processed sensing data e.g., as requested by a sensing service client (e.g., the sensing client 34). For example, the processed sensing data may be sensing data that has been processed by the SeMF. The processed sensing data may include data about the objects in an area and/or data about features or data about those objects. For example, one or more of the location, speed, velocity, shape, material, and/or dimensions of the object may be data about the objects in an area. The SeMF may alternatively or additionally be configured to provide the sensing data received or collected from one or more sensing devices as a sensing output. The SeMF may provide to the sensing service client sensing data if the sensing data has been requested by the sensing service client.

The sensing service client 34 may be for example:
an application function (e.g., trusted to the Public Land Mobile Network (PLMN)) and the request may be received directly from the sensing service client;
an application function and the request received from the sensing service client via a network exposure function;
a user equipment; or
another network entity, such as a RAN node and/or network function of a wireless communication system, such as a network function of a core network of a wireless communication system.

A RAN entity 36 may be, for example, a base station (e.g., an evolved NodeB (eNB) or gNB), or another entity with at least some of the sensing functionalities (i.e. the sensing functionalities may include at least one of the following: provide sensing and/or positioning measurements, transmit the signals for sensing and/or positioning) and could be a new network node (e.g., dedicated for sensing purposes, sensing unit) or part of an existing network node (e.g., Positioning Reference Unit, Reconfigurable Intelligent Surfaces). A RAN entity may validate and realize the sensing configurations received from the sensing management module 32. A RAN entity 36 may also conduct sensing admission control on sensing resources for transmitting (Tx) and/or receiving (Rx) sensing signal(s) and updating and/or selecting the sensing configuration of the RAN entity 36, which is then provided to the sensing management module 32 and/or to other RAN entities (e.g., via an Xn interface). Any RAN entity 36 operating as a sensing receiver may then obtain sensing data and provide that sensing data to the sensing management module 32 (with or without processing the sensing data), according to the sensing data reporting configurations for processing the sensing data to derive sensing outputs.

As discussed above, the sensing management module 32 may be, may implement, or may comprise a Sensing Management Function (SeMF). The sensing management module may be provided or included in a communication system, such as 5GS. The SeMF may be a dedicated network function for the core network of the communication system (e.g., a network function for the 5GC (5G core network of the 5GS) or a dedicated network function for one or more RAN entities 36. In some embodiments, the SeMF (e.g., functionality of the SeMF) may be integrated into an existing network function for a wireless communication system (e.g., an existing network function for the 5GS or for the 5GC of the 5GS), such as a location management function (LMF) which provides location services for locating user equipment in a 5GS. In some embodiments, the functionalities of the SeMF may be distributed across a plurality of different network functions of the core network (e.g., NEF, LMF, GMLC, AMF) or may be integrated into one or more RAN entities 36).

In an example implementation, the SeMF may:
Determine a sensing method (e.g., monostatic sensing, bistatic sensing, or mutli-static sensing) and determine a sensing configuration for the RAN entities (e.g. BSs, such as gNBs) identified or selected to be involved in a sensing session for the determined sensing method taking into consideration a) the requirements included in a sensing service request received from the sensing serving client 34 (e.g. sensing area for the sensing service, QoS requirements for the sensing service) and b) the static and/or dynamic sensing capabilities of RAN entities. In the case the determined sensing method is monostatic sensing, the SeMF may identify or select one or more RAN entities to be involved in and determine or generate a sensing configuration for the one or more RAN entities for configuring the one or more RAN entities as a sensing transmitter (Tx) and a sensing receive (Rx) based on the determined sensing method, and provide the sensing configurations to the one or more RAN entities. Alternatively, in the case of bistatic sensing and/or multi-static sensing is determined, identify or select one RAN entity to be a sensing transmitter and one or more other RAN entities (e.g., BSs) to be sensing receivers and determine or identify a sensing configuration for configuring the one RAN entity to be a sensing transmitter and sensing configurations for configuring the one or more other RAN entities (e.g., BSs) to be a sensing receiver.
Execute sensing admission control, which identifies whether the identified or selected RAN entities have the available sensing resources for the requested sensing service (e.g., sensing requirements) and determine a sensing resources configuration for the identified or selected RAN entities. The sensing resources configuration may include reference signals and/or pilots and/or user data and control plane resources, depending on the approach or scheme that a selected monostatic, bistatic or multi-static method realizes.
Transmit a sensing session establishment request to the one or more RAN entities to establish a sensing session, according to the selected sensing method (monostatic, bistatic or multi-static sensing), including one or more of the following: a sensing configuration for each respective selected RAN entity for configuring the respective RAN entity as a sensing transmitter and/or sensing receiver; sensing resources configuration; sensing session configuration; sensing data reporting configuration i.e. whether control plane-based reporting or user plane (e.g. to or via dedicated server) will be used to transfer the sensing measurements (sensing data) from the RAN entity (e.g., BS) to SeMF, resources and configurations used for reporting; one or more identifiers of sensing sessions. Each identifier of a sensing session identifies the sensing session and is generally referred to as sensing session identifier and collectively referred to as sensing session identifiers).
Generate and allocate to the one or more RAN entities involved in the selected sensing session for the determined sensing method a sensing session identifier (ID) used to uniquely identify and coordinate sensing operations among different RAN entities as well as for transmitting sensing measurements and/or sensing data from the RAN entity (or RAN entities) to the SeMF, that belong to the same sensing session.

In the context of the same sensing session, one or more mono-static sensing operations or one or more multi-static sensing operations can be initiated. Also, the same RAN entity can be involved at one or more mono-static sensing operations and at one or more multi-static sensing operations. In addition, a RAN entity can identified or selected to be a sensing transmitter and can be configured based on the sensing configuration to transmit sensing signals and/or identified or selected to be sensing receiver and can be configured to based on a sensing configuration to receiver sensing signals. Each of the one or more RAN entities 36 of the system 30 may be a base Station (BS) or some other entity with sensing capabilities (e.g., dedicated units or elements to receive sensing signals, Reconfigurable Intelligent Surfaces with integrated sensing capabilities or used to aid in ISAC). Each RAN entity 36 may:
Transmit a response to a sensing session establishment request to the SeMF. The response to the sensing session establishment request comprises an indication of acceptance (success) or failure to provide and/or support and/or establish the sensing session. The response to the sensing session establishment request may also include a cause code indicating a cause of the failure to provide and/or support and/or establish the sensing session.
Configure itself after establishment of the sensing session according to the received sensing resources configuration and sensing session configuration and cause the respective RAN entities to perform a sensing operation.
When involved in a sensing session (e.g., identified by a sensing session ID) and configured to be or as a sensing receiver, transmit to the SeMF the respective sensing data (e.g., measurements obtained when the RAN entity is performing a sensing operation).
Optionally conduct sensing admission control and determine the sensing resources for transmitting or receiving sensing signals based on the sensing resources configuration received from the SeMF.

The interaction between the SeMF and the RAN entity(-ies) can happen through direct interface (e.g., in case a core network has a Service based architecture) or though the AMF. The AMF may route the messages between a RAN entity (e.g., an access node) and the SeMF transparently, over an interface (e.g., over an NG-C interface) using a non-UE associated mode. The Next Generation Application Protocol (NGAP) protocol, terminated between the AMF and the RAN entity (e.g., a NG-RAN node), may be used as a transport protocol for transporting sensing protocol messages over the NG-C interface.

In some embodiments, admission control may be performed by a RAN entity (e.g., BS). The SeMF may provide to the RAN entity (e.g., BS) information such as a QoS for the requested sensing session, an indication of a type of sensing service that is requested, sensing requirements for the sensing session (e.g. sensing area, sensing duration, sensing update rate etc.) that can allow the one or more RAN entities (e.g., BSs) to determine the required resources for the sensing session. The RAN entity (e.g., BS) configured to be or as a sensing transmitter (e.g., having a sensing transmitting role (e.g. when the SeMF selects the RAN entity to be involved in a bi-static sensing method) can provide its sensing resource configuration (e.g. sensing signal frequency, bandwidth, the timing when a sensing signal is transmitted by the RAN entity (e.g., BS)) and/or the sensing session configuration to: one or more RAN entities (e.g., BSs) configured to be or as sensing receiver (e.g., having a sensing receive role) for the respective sensing session e.g. via the Xn interface (inter-RAN entity); or the SeMF e.g. via the NG interface or; the AMF e.g. using similar mechanism as the Remote interference management (RIM) Information Transfer.

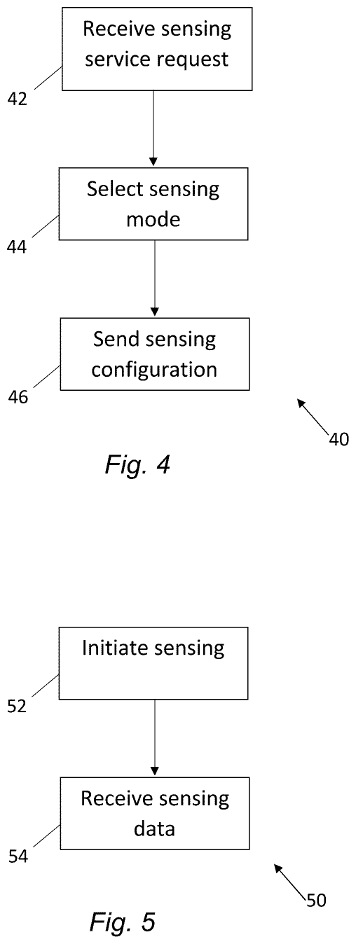

FIG. 4 is a flowchart showing a method or process indicated generally by the reference numeral 40, in accordance with an example embodiment. The method or process 40 may be performed by the SeMF implemented or comprised in the sensing management module 32 described above.

The method or process 40 starts at operation 42, where a sensing service request is received (e.g., at the sensing management module 32) from a sensing service client (such as the sensing client 34). The sensing service request is a request for a sensing service supported or provided by the sensing management module 32. The sensing service request includes information related to the sensing service that is requested by the sensing client. Example information related to the sensing service that may be included in a sensing service request include at least one of: an indication of a sensing service type for the sensing service; information indicating sensing requirements for the sensing service; an indication of a quality of service for the sensing service; and information indicating a sensing area for the sensing service.

At operation 44, a sensing method (e.g., a sensing mode) is selected based, at least in part, on the information related to the sensing service (e.g., as included in the operation 42). The operation 44 may involve selecting between one of: monostatic sensing for the sensing service, in which a first RAN entity (e.g., a radio access network node) is used for transmission and reception of radio signals used for sensing, and multi-static sensing (e.g. bistatic sensing), in which one selected radio access network node is used for transmission of radio signals for sensing and one or more other selected radio access nodes are used for reception of radio signals used for sensing.

At operation 46, sensing configuration information is sent (e.g., from the sensing management module 32 to the RAN entities 36). For example, if monostatic sensing has been selected in the operation 44, the operation 46 may involve sending, to the first RAN entity (e.g., radio access network node) used for transmission and reception of radio signals used for sensing, a sensing configuration for the first RAN entity (e.g. the radio access network node (such as sensing configuration might include at least one of a sensing resource configuration, a sensing session configuration, and a sensing data reporting configuration). If multi-static (e.g. bistatic) sensing has been selected in the operation 44, the operation 46 may involve sending, to the one selected radio access network node used for transmission of radio signals used for sensing, a sensing configuration for the one selected radio access network node (such as sensing configuration might include at least one of a sensing resource configuration, a sensing session configuration, and a sensing data reporting configuration).

Moreover, in the event that multi-static sensing is selected, the operation 46 may further comprise sending, to each respective other radio access network nodes used for reception of radio signals, a sensing configuration for the respective other radio access network node. It should be noted that the sensing configuration of the respective other radio access node(s) could be sent by one of the RAN nodes 36 (e.g., the other node in the bistatic case), rather than by the sensing management module 32. In common with the sensing configuration examples discussed above, the sensing configuration for each respective other radio access network node may comprises at least one of a sensing resource configuration, a sensing session configuration, and a sensing data reporting configuration.

FIG. 5 is a flowchart showing a method or process, indicated generally by the reference numeral 50, in accordance with an example embodiment. The method or process 50 may be implemented at the sensing service client 34 of the system 30 described above.

The method or process 50 starts at operation 52, where a sensing session is initiated. The initiation of the sensing session may form part of the sensing configuration operation 46 described above. In some example embodiments, initiating of the sensing session may be implemented only following a validation process that determines that the respective RAN entity is able to initiate the sensing session for the requested sensing service. The operation 52 may include sending, to the respective RAN entity, a request for that RAN entity to initiate sensing.

At operation 54, sensing data is received. The sensing data may be received from the first selected radio access network node used for transmission and reception of radio signals for sensing (when the first selected radio access network node is configured for mono-static sensing). Alternatively, the sensing data may be received from the one or more other selected radio access network nodes used for reception of radio signals used for sensing (when the first radio access network node and the one or more other radio access network nodes are configured for multi-static sensing).

The sensing data may be processed in some way, as discussed in detail below. For example, the sensing data may be processed at the respective RAN or at the sensing management module 32, with processed data being provided to the sensing service client 34 (in response to the original request from the sensing client).

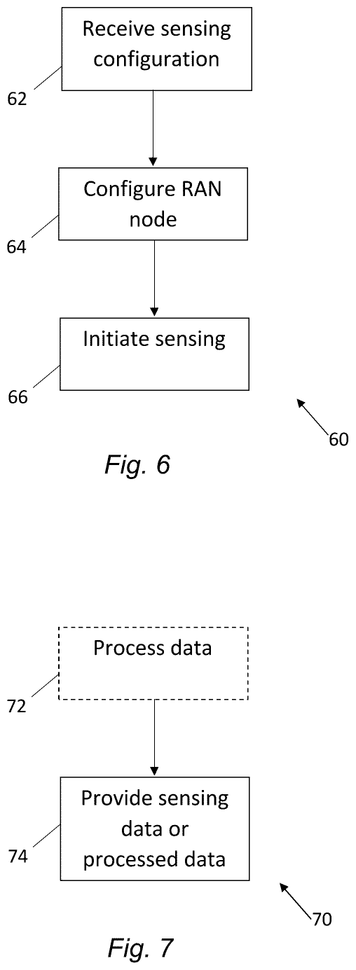

FIG. 6 is a flowchart showing a method or process, indicated generally by the reference numeral 60, in accordance with an example embodiment. The method or process 60 may be implemented at one of the one or more RAN entities 36 of the system 30 described above.

The method or process 60 starts at operation 62, where a sensing configuration for a sensing service is received at a RAN entity (e.g., a radio access network node of a wireless communication system) from a sensing management function (e.g., the sensing management module 32) of the communication system. The sensing configuration may be sent in the operation 46 described above and may be used by the RAN entity to configure itself for one of monostatic sensing for the sensing service (in which the radio access network node is a first selected radio access network node used for transmission and reception of radio signals used for sensing) and multi-static sensing (in which the radio access network node is one selected radio access network node used for transmission of radio signals for sensing or one of one or more other selected radio access nodes used for reception of radio signals used for sensing).

At operation 64 of the method or process 60, the RAN entity (e.g., the radio access network node) configures itself in accordance with said sensing configuration.

At operation 66, the RAN entity (e.g., the radio access network node) initiates the sensing operation for the sensing service. As discussed in detail herein, sensing is by the transmission of sensing signals (e.g., radio signals) for sensing (e.g., by one RAN entity) and the reception of radio signals for sensing (e.g., by the same RAN entity, or one or more different RAN entities).

FIG. 7 is a flowchart showing a method or process, indicated generally by the reference numeral 70, in accordance with an example embodiment. The method or process 70 may be implemented at one of the one or more RAN entities 36.

At operation 72 of the method or process 70 (which may be omitted in some example embodiments), sensing signals (e.g., radio signals) for sensing (as received by the respective RAN entity) are processed to generate sensing data.

At operation 74 of the method or process 70, data is provided (e.g., from the respective RAN entity 36 to the sensing management module 32. The data may be a received sensing signals or other sensing data (in which case the operation 72 may be omitted). Alternatively, the data may be sensing data as processed in the operation 72 (e.g., the output of the operation 72).

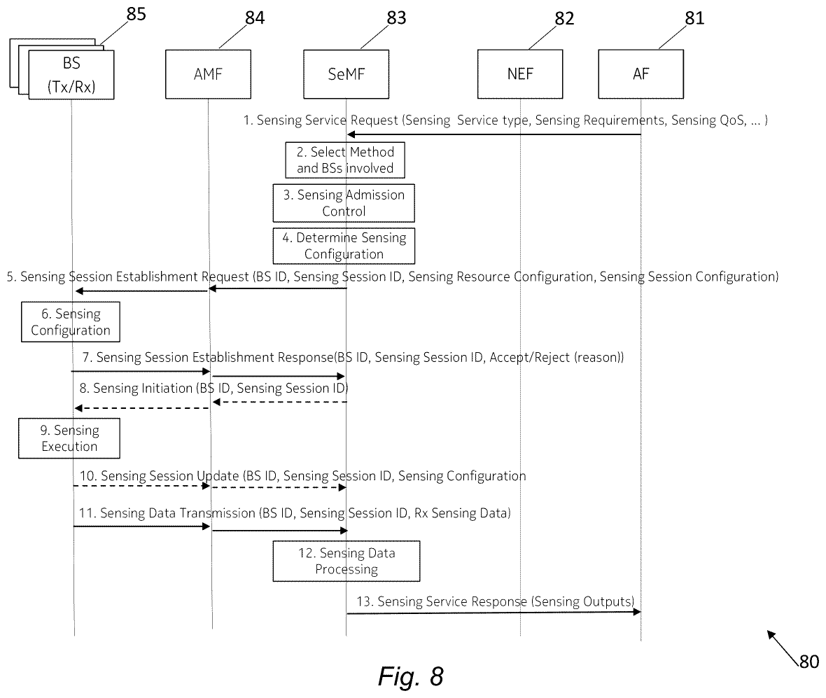

FIG. 8 shows a message flow sequence and operations of a procedure, indicated generally by the reference numeral 80, in accordance with an example embodiment. The procedure 80 shows messages being sent between an Application Function (AF) 81, a network exposure function (NEF) 82, a Sensing Management Function (SeMF) 83, an Access and Mobility Management Function (AMF) 84 and one or more RAN entities (e.g., base stations (BS) 85) of a 5G wireless communication system and operations being performed by the SeMF 83 and one of the RAN entities (e.g., one of the base stations 85). It should be noted, however, that the principles of the procedure 80 could be applied to other communication systems.

The procedure 80 is a procedure to configure and enable RAN entities (e.g., BSs) of a communication system for monostatic sensing, where the admission control (e.g., resource allocation) takes place at the SeMF 83.

The procedure 80 starts at step 1, where a sensing client (in this example embodiment the AF 81) sends a request for a sensing service (generally referred to as a sensing service request) to a SeMF 83 of a communication system (e.g., a core network of a communication system, such as 5G core network, 5GC of a 5G communication system). The SeMF 83 is configured to support or provide different types of sensing services. The AF 81 may send the sensing service request either directly to SeMF 83 (or shown in FIG. 8) or via the NEF 82. The sensing service request sent by the sensing client may include information related to the sensing service that is requested.

The information included in this sensing service request may include a QoS for the sensing service that is requested, an indication of a type of sensing service that is requested, information indicative of sensing requirements for the sensing service that is requested, and information indicative of a sensing area for the sensing service that is requested.

In step 2, the SeMF 83 determines a sensing method to be used for the sensing service that is requested and selects the RAN entities, according to the information related to the sensing service included in the sensing service request (received at step 1). In the example procedure 80, the SeMF 83 selects one or more RAN entities (e.g., BSs) 85 that are to be involved (as sensors) in a sensing session for the sensing service that is requested which are both a sensing transmitter and a sensing receiver and the selected (as the sensing method selected by the SeMF 83 is a monostatic sensing in this example embodiment).

The SeMF 83 uses the sensing capabilities (e.g., methods, sensing features) of each RAN entity (e.g., BS) 85, which can be stored at the SeMF or another NF or even at an operations, administration, and management (OAM) system. In addition, the SeMF 83 may use other information related to the RAN entities (e.g., BSs 85) for the selection of the RAN entities (e.g. BSs) 85 that are to be involved in the sensing session for the sensing service such as computational load, availability of sensing resources, and/or availability or load of the RAN entities (e.g. BSs) 85.

As part of step 2, the SeMF 83 selects one or more RAN entities (e.g., BSs and optionally cells) that are to be involved in the sensing session for the sensing service, where each RAN entity (e.g., BS) 85 that is selected has the role of a monostatic sensor (e.g., is a monostatic sensor which means that the RAN entity (e.g., BS 85) transmits and receives sensing signals):
Each monostatic sensor has a Sensor Identifier (Sensor ID) which identifies the RAN entity (e.g., BS) 85 that is selected. A Sensor ID of a monostatic sensor may include:
   an identifier of the RAN entity (e.g., BS ID); and/or
   and optionally an identifier of a cell (e.g., Cell ID).

In step 3, the SeMF 83 performs sensing admission control to check whether each selected RAN entity (e.g., BS) 85 has resources available according to the sensing requirements (e.g., duration, update rate) and required QoS (e.g., sensing accuracy, sensing resolution, sensing delay). The SeMF 83 determines, for each respective RAN entity (e.g., BS) 85 a sensing configuration. The sensing configuration for each respective RAN entity (e.g., BS) 85 includes a sensing resource configuration for the respective RAN entity (e.g., BS) 85 and a sensing session configuration. The sensing resource configuration for a respective RAN entity (e.g., BS) 85 includes information about resources that should be used for the sensing session by the RAN entity (e.g., BS) 85, including one or both of the following:
Option a) Pilots or Reference Signals that will be used for the sensing session; or
Option b) User plane and control plane resources used for sensing session e.g., resource blocks, time or frequency resources, selected frequency band assigned for PDSCH to deliver control plane messages and/or user plane data. The SeMF 83 can optionally provide user plane configuration information for the user plane transmission (e.g., bandwidth used, duration of user plane transmission, amount of data to be transmitted), for instance according to sensing service requirements. Alternatively, a code can be provided that can allow the RAN entity (e.g., BS) 85 to identify or retrieve user plane configuration information.

If the outcome of the admission control and resources availability check is that required resources are not available, then step 2 as discussed above may be repeated.

As discussed further below, in other example embodiments, sensing admission control may be performed by another entity, such as a RAN entity (e.g., BS) 85.

In step 4, the SeMF 83 determines (according to the outputs of step 3) the sensing session configuration that could be used for configuring the RAN entity appropriately and/or optimize sensing transmission and reception, including sensing method, sensing QoS parameters, sensing session duration, timing and location information for the sensing, type of sensing service: request or subscription, RAT type used for sensing, bandwidth for sensing etc.

The SeMF 83 can split the sensing operation to different RAN entities (e.g., BSs) 85, and also different sensing configurations could be used for the different BSs. For instance, different parts of the sensing area described in the sensing request (as received in step 1) can be assigned to the different involved RAN entities (e.g., BSs) 85. In this embodiment, multiple sensors (or sensing sub-sessions, or sensing flows) can be established with a unique identifier (ID) for each sensor (or sensing sub-session). The unique identifier for a sensor identifies the sensor (or sensing sub-session). The SeMF 83 may manage mapping information that multiple (concurrent) sensors (or sensing sub-sessions) are associated with a given identifier of a sensing session and/or sensing service request from a sensing client.

The SeMF 83 generates the sensing data reporting configuration (e.g., whether control plane reporting or user plane (e.g., to or via dedicated server) will be used to transfer the sensing measurements from a RAN entity (e.g., BS) 85 to SeMF 83). Optionally resources and configuration used for reporting can be defined.

In step 5, the SeMF 83 sends to the one or more RAN entities (e.g., BSs) 85 selected to be involved in the sensing operation, a request to establish a sensing session for the requested sensing service. The request to establish a sensing session is generally referred to as a sensing service establishment request and the request includes one or more of the following information:
an identifier of the sensing session (generally referred to as a Sensing Session ID, generated by the SeMF 83 to facilitate the coordination and handling of the sensing operation for the specific sensing service that is requested;
an identifier of the RAN entity e.g., a BS ID (e.g., Global gNB ID or 6G Node B ID) and/or a Cell ID (e.g., NR CGI or 6G Cell Global ID);
the sensing session configuration, as determined in step 4;
the sensing resources configuration, as determined in step 3 that includes the resources that will be used for sensing by each RAN entity (e.g., BS) 85 involved in the sensing operation; or
the sensing data reporting configuration, as determined in step 4.

In step 6, each RAN entity (e.g., BS) 85 that has received the sensing session establishment request undertakes to check and implements and/or applies the sensing session configuration and the sensing resources configurations received by the SeMF 83.

In step 7, the RAN entity (e.g., BS) 85 transmits a response to the sensing session establishment request that includes an indication about the success or failure to establish the requested sensing session. The response may also include a failure cause code indicating the reason of the failure to establish the requested sensing session.

Optionally, the RAN entity (e.g., BS) 85 can determine and transmit to the SeMF 83 another configuration for sensing (e.g., sensing session configuration, sensing resources configuration, sensing data reporting configuration) either in the response message or in a separate message.

In step 8 (which may be optional), the SeMF 83 informs the respective RAN entity (e.g., BS) 85 to initiate the sensing session identified by the Sensing Session ID. This step may be performed, for instance, in embodiments where it is required to start the sensing operations at multiple RAN entities (e.g., BSs) in coordinated manner. The sensing session establishment request may include an indication (e.g., a flag) that indicates to the RAN entity (e.g., BS) 85 to wait or not wait for a notification from the SeMF to start the sensing operation.

In step 9, the RAN entity (e.g., BS) 85 executes or performs a sensing operation by allocating and/or scheduling resources according to the received sensing configuration. The RAN entity (e.g., BS) 85 transmits reference signals and/or pilots or Physical Downlink Channel for user data with frequency, time and spatial (i.e. Tx antenna, beam) resources required to satisfy a QoS for the requested sensing service. The RAN entity (e.g., BS) 85 also attempts to receive and measure its own transmitted signal with the sensing configuration received for sensing.

In step 10 (which may be optional), the RAN entity (e.g., BS) 85 can transmit to the SeMF 83 information about updated sensing configuration, for instance due to local (RAN entity (e.g., BS) 85) decision and/or due to changes during the execution of step 9 at the RAN entity (e.g., BS) and/or due to changes at the sensing environment and/or conditions and/or measurements. The RAN entity (e.g., BS) 85 can provide the updated sensing configuration to the SeMF 83 by sending a message that includes the updated sensing configuration. Based on the updated sensing configuration, the SeMF can update the respective sensing session, including any element that has been provided in step 5. The SeMF 83 may transmit the updated configuration to the respective BS(s).

In step 11, the RAN entity (e.g., BS) 85 provides to the SeMF 83 sensing data (e.g., the measurements of the conducted sensing operation), identified by the Sensing Session ID and the identifier of the RAN entity (e.g., BS ID), using the sensing data reporting configuration.

In step 12, the SeMF 83, based on the received sensing data from the one or more RAN entities (e.g., BSs), processes the collected sensing data to generate the sensing output.

Steps 9 to 11 can be repeated or iterated, before sending the response to the sensing service request.

In step 13, the SeMF 82 provides the sensing output to the requesting sensing client e.g., to the AF 81 directly or via the NEF 82.

It should be noted that multiple monostatic RAN entities (e.g., BSs) could be selected for the same sensing session. The SeMF 83 may keep and/or maintain and/or store a list of the identifiers of RAN entities (e.g., BS IDs) involved in each sensing session (identified by the sensing session ID), a context for each RAN entity (e.g., BS), for example, sensing capabilities, a QoS for the sensing session) as well as the determined configuration of the sensing session and sensing resources configuration. For instance, SeMF 83 may keep and/or maintain and/or store the following information:
an identifier of a sensing session (e.g., Sensing Session ID)
Quality of service for the requested sensing service (referred to herein as Sensing QoS)
RAN entities (e.g., BSs) involved in the sensing session, including, for each RAN entity involved in the sensing session, one or more of the following information:
   Sensor ID;
   RAN entity ID (e.g., BS ID);
   Cell ID (e.g., identifier of a cell);
   Sensing Method (e.g., bistatic or monostatic sensing);
   Sensing Capabilities of Sensor ID;
   Sensing Session Configuration of Sensor ID;
   Sensing Resources Configuration of Sensor ID;
   Sensing Data Reporting configuration of Sensor ID;

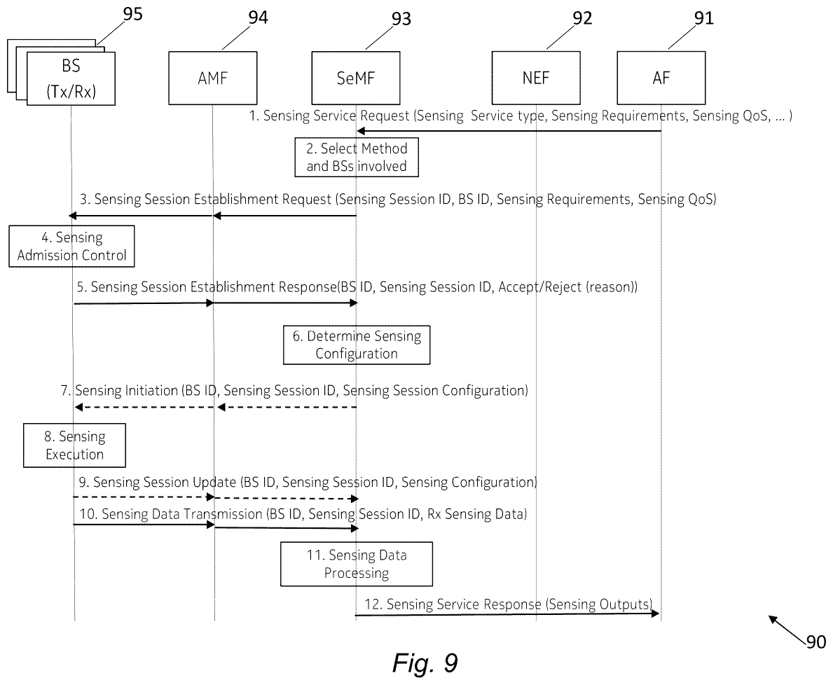

FIG. 9 shows a procedure, indicated generally by the reference numeral 90, in accordance with an example embodiment. The procedure 90 shows messages (e.g., control plane messages) being sent between an Application Function (AF) 91, a network exposure function (NEF) 92, a Sensing Management Function (SeMF) 93, an Access and Mobility Management Function (AMF) 94 and one or more RAN entities (shown as base stations (BS) 95 in FIG. 9) of a 5G wireless communication system. It should be noted, however, that the principles of the procedure 90 could be applied to other wireless communication systems.

The procedure 90 is an alternative to the procedure 80 described above. In the procedure 90, a RAN entity (e.g., a BS 95) is responsible for conducting a check on the availability of sensing resources, for selecting sensing resources for the sensing session, and setting the respective sensing configurations.

In step 1 of procedure 90, a sensing client (e.g., AF 91) sends a sensing service request to the 5G core (5GC). The sensing client (e.g., AF 91) sends the request either directly to SeMF 93 or to SeMF 93 via NEF 92. The sensing service request comprises information that depends on the scenario and the application. The information may include a sensing QoS (i.e., a QoS for the requested sensing service), an indication of a sensing type for the requested sensing service, sensing requirements for the requested sensing service, and an indication of a sensing area for the requested sensing service.

In step 2, the SeMF 93, according to the information included in the sensing service request, determines the appropriate sensing method and the sensing configuration. In step 2, the SeMF 93 may select one or more RAN entities (e.g., BSs 95) that are to be involved (as sensors) in a sensing operation for the requested sensing service. The SeMF 93 may use the sensing capabilities of (e.g., sensing methods supported by, sensing features of) each RAN entities BS 95, which can be stored at the SeMF or another NF or even at the OAM, to select the one or more RAN entities (e.g., BSs 95) to select the one or more RAN entities (e.g., BSs 95) to be involved (as sensors) in a sensing operation for the requested sensing service. In addition, the SeMF may use other information of the RAN entities (e.g., RAN entity load) to select the one or more RAN entities (e.g., BSs 95) that are to be involved in the sensing operation for the sensing service.

In step 3, the SeMF 93 sends a sensing session establishment request to the one or more RAN entities (e.g., BSs) 95 (e.g., via the AMF 94) that are selected to be involved in the sensing session. The sensing establishment request including one or more of the following information:
the identifier of the sensing session (e.g., sensing session ID), generated by the SeMF 93 to facilitate the coordination and handling of the sensing operations for the requested sensing service;
the identifier of the selected RAN entity (e.g., identifier of BS (e.g., BS ID);
sensing requirements for the sensing service that is requested (e.g., sensing area, duration, update rate);
a QoS for the sensing service that is requested (e.g., sensing accuracy, sensing resolution, sensing delay); or
an indication of a sensing method for the sensing service that is requested (e.g., an indication of mono-static sensing, of bi-static, of sensing using user plane resources, of sensing using pilots signal and/or reference signals).

The SeMF 93 can split the sensing operation among different BSs, and also different sensing configurations could be used for the different BSs. Thus, different sensing session establishment requests may refer to different areas and/or focus on different sensing features.

In step 4, the BS 95 that has received the sensing session establishment request checks whether it has the available resources according to the sensing requirements and required sensing QoS. At this phase each BS 95 determines the sensing resources configuration, which defines the resources that will be used for sensing by each involved BS, including one or both of the following:
Option a) Pilots or reference signals that will be used for sensing; or
Option b) User plane and control plane resources used for sensing e.g., resource blocks, time or frequency resources, selected frequency band assigned for PDSCH to deliver control plane messages and/or user plane data to 5GC.

In step 5, the RAN entity (e.g., BS) 95 transmits a response to the sensing session establishment request comprising an indication of success or failure to establish the requested sensing session. The response may also include a cause code indicating the failure cause (in case the response includes an indication of failure to establish the requested sensing session). Optionally, the RAN entity (e.g., BS) 95 may include information about the sensing resource configuration, e.g., selected resources.

In step 6, according to the outputs of step 5, the SeMF 93 determines the sensing session configuration including the involved RAN entities or cells (e.g., the BS or cells selected for the sensing session), sensing resource configuration information and other information about the sensing session identified by the sensing session ID and each RAN entity identified by a BS ID (e.g., sensing QoS parameters, sensing session duration, and/or timing and location information for the sensing).

According to the outputs of the admission control and resources availability check at the RAN entity (e.g., BS) 95, the SeMF 93 can return to the step 2.

In step 7, the SeMF 93 informs the respective RAN entities (e.g., BS(s)) 95 to initiate the sensing session identified by the sensing session ID. This step may be needed, for instance, in case it is required to start the sensing operations for a sensing session at multiple RAN entities (e.g., BSs) in coordinated manner. The sensing data reporting configuration can be also included in this message, which can be determined in step 6. Note that some or all of step 7 may be omitted in some example embodiments.

Steps 8 to 12 are the same as corresponding steps of the message sequence 80 described above and are not discussed further here.

Steps 2 to 6 can be repeated several times according to the outcome of sensing admission control at the requested RAN entities (e.g., BSs).

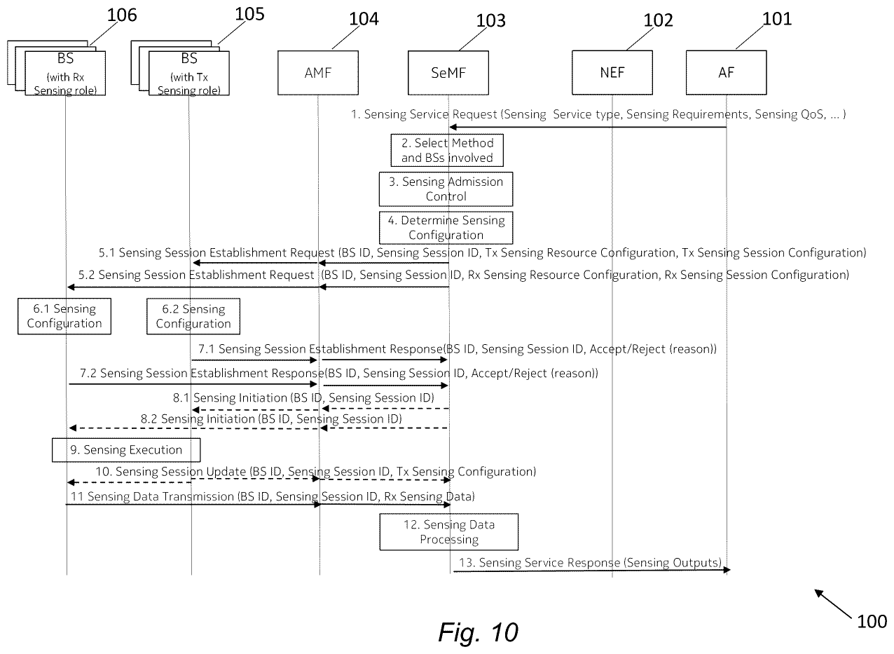

FIG. 10 shows a message flow sequence and operations of a procedure, indicated generally by the reference numeral 100, in accordance with an example embodiment. The procedure 100 includes messages (e.g., control plane messages) being sent between an Application Function (AF) 101, a network exposure function (NEF) 102, a Sensing Management Function (SeMF) 103, an Access and Mobility Management Function (AMF) 104 and one or more RAN entities 105 of a 5G wireless communication system. It should be noted, however, that the principles of the message sequence 100 could be applied to other communication systems.

The procedure 100 is a procedure to configure and enable RAN entities (e.g., BSs) of a communication system for bi-static sensing, while the admission control (e.g., resource allocation) takes place at the SeMF 103. It should be noted that although the procedure 100 is described in relation to bi-static sensing, the same principles are applicable to multi-static sensing.

Step 1 of procedure 100 is the same as step 1 of the procedures 80 and 90 discussed above.

In step 2, the SeMF 103 according to the inputs of the sensing request message (step 1) determines the sensing method for a sensing session and identifies and/or selects one or more RAN entities to be involved in the sensing session for the requested sensing service based on the determined sensing method. The inputs (e.g., requirements for the sensing service) included the sensing request depends on the scenario and the application and may include sensing QoS, sensing type, sensing service, sensing requirements, and/or sensing area. In the specific embodiment that the SeMF 103 determines the sensing method is a bi-static sensing method, the SeMF 103 identifies and/or or selects one RAN entity (e.g., BS_105 to be involved (as a sensing transmitter) in the sensing session for the requested sensing service and generates a sensing configuration for one of the RAN entity for configuring the one RAN entity to be or as a sensing transmitter. The SeMF 103 also identifies and/or selects and another RAN entity (e.g., BS) 106) be involved (as a sensor) in the sensing session for the requested sensing service and generates a sensing configuration for configuring the another RAN entity (e.g., BS) 106) to be or as a sensing receiver.

The SeMF 103 uses the sensing capabilities (i.e., methods, sensing features) of each RAN entity (e.g., BS), which can be stored at the SeMF or another NF or even at the OAM for the selection of the RAN entities for a sensing session for the requested sensing service. In addition, other information of the RAN entities could be taken into consideration for the selection of the RAN entity (e.g., BS) for the sensing session such as computational load, sensing resources availability or load etc.

In the multi-static sensing method, the SeMF 103 selects a plurality of RAN entities (e.g., BSs) where the one of selected RAN entities transmit sensing signals and the other ones of the selected RAN entities receive the sensing signals (e.g., are configured to be or as a sensing receiver). Each selected RAN entity is selected for a particular sensing role (e.g., selected to be a sensing transmitter or a sensing receiver) and can be identified by (or is associated with) a sensor ID that can include:
Identifier of RAN entity that transmits Sensing signals:
   BS ID)
   Cell ID
Identifier(s) of RAN entity(-ies) that Receive Sensing Signals:
   BS ID(s)
   Cell ID(s)

Note that the selection of a cell (e.g., identified by a cell ID) resulting the selection of a RAN entity for sensing (either as a transmitter, a receiver, or both).

In step 3, the SeMF 103 checks whether each selected RAN entity selected for a sensing transmitter or a sensing receiver role has available resources according to the Sensing Requirements (e.g., duration, update rate) and required sensing QoS (e.g., sensing accuracy, sensing resolution, sensing delay). At this phase the SeMF 103 determines the resources that should be used for sensing by each RAN entity (Tx Sensing Resource Configuration or Rx Sensing Resource Configuration), including one or both of the following:
Option a) Pilots or Reference Signals that will be used for sensing; or
Option b) User plane and control plane resources used for sensing e.g., resource blocks, time or frequency resources, selected frequency band assigned for PDSCH to deliver control plane signalling and/or user-plane data.

According to the outputs of the admission control and resources availability check, the SeMF can return and repeat the step 2.

In step 4, according to the outputs of step 3, the SeMF determines also the sensing session configuration of each RAN entity selected to be a sensing transmitter or sensing receiver for a sensing session for a bi-static sensing operation that could be used to configure appropriately and/or optimize transmission and/or reception of sensing signals by the RAN entity, sensing QoS parameters, sensing session duration, timing and location information for the sensing, type of sensing service: request or subscription, sensing method, RAT type, and/or bandwidth needed.

The SeMF 103 can split the sensing operations for a sensing session to be performed different RAN entities, and also different sensing configurations could be used by each RAN entity. For instance, different parts of a area to be sensed, identified by information included in the sensing service request can be assigned to the different RAN entities (e.g., BSs) that will be configured to be or as a sensing transmitter (and the respective one or more RAN entities (e.g., BSs) configured to be or as a sensing receiver).

As part of sensing configuration for RAN entity to be configured as a sensing receiver, the RAN entity (e.g., BS) can be configured with receiving all sensing signal from all RAN entities (BSs) configured to be or as sensing transmitter or limited to some of RAN entities (e.g., BSs) configured to be or as sensing transmitters.

In step 5, the SeMF 103 sends a Sensing Session Establishment Request to the one or more RAN entities (e.g., BSs) (e.g. via the AMF 104) that are selected to be involved in a sensing session (e.g., the RAN entity that is selected to be a sensing transmitter (step 5.1) and the RAN entities selected to be sensing receivers (step 5.2) for bi-static sensing. Each Sensing Session Establishment Request may include one or more of the following information:
the sensing session ID, generated by the SeMF 103 to facilitate the coordination and handling of the sensing operations for the sensing session for the requested sensing service;
the BS ID, the Cell ID;
an indication that the RAN entity is to be configured to be or as a sensing Transmit or a sensing receiver;
the sensing session configuration, as defined in step 4;
the sensing resources configuration, as determined in step 3 that includes the resources that will be used for sensing by each involved BS; or
the sensing data reporting configuration, as determined in step 4.

In step 6, each RAN entity (e.g., BS) that has received the sensing session establishment request undertakes to implement or apply the sensing session and sensing resources configurations received by the SeMF.

In step 7, the RAN entities (e.g., BSs) each send a sensing session establishment response to the sensing session establishment request. Each sensing session establishment response includes an indication of the success or failure to provide the requested sensing session (and optionally a cause code that indicates a cause of the failure to establish the sensing session when the indication indicates failure to establish the sensing session). Optionally, any RAN entity (e.g., BS) can determine and transmit to the SeMF another configuration for sensing (e.g., sensing session configuration, sensing resources configuration, sensing data reporting configuration).

Based on received notifications and/or responses, the SeMF 103 can review and/or check and update the RAN entities (e.g., BSs) with the confirmed list of RAN entities (e.g., BSs) that have been selected to be a sensing transmitter and/sensing receiver. Updated list of RAN entities (e.g., BSs) and information about whether the RAN entity is to be configured to be or as a sensing receiver or a sensing transmitter can be included in the message(s) transmitted at step 8.

In step 8 (which may be omitted in some example embodiments), the SeMF 103 informs the respective RAN entity (e.g., BS) to initiate the sensing operations for a sensing session identified by the sensing session ID. This step may be needed, especially in the bi-static method to ensure that RAN entities (BSs) configured to be or as a sensing transmitter will not initiate a sensing operation for a sensing session before the RAN entity (e.g., BS) is configured to be a sensing receiver. As well as, in case it is required to start the sensing operations for a sensing session at multiple BSs in coordinated manner. The sensing data reporting configuration can be also provided to the RAN entities (e.g., BSs) configured to be or as a sensing transmitter and/or sensing receiver, which can be determined by the SeMF 103.

In step 9, the RAN entities (BSs) performing sensing, according to whether they are configured to be or as a sensing transmitter and/or sensing receiver, allocating or scheduling resources according to the received sensing configurations. The RAN entity (e.g., BS) 105 configured to be or as a sensing transmitter role transmits reference signals, pilots or Physical Downlink Channel for user data with frequency, time and spatial (i.e. Tx antenna, beam) resources required to satisfy a QoS requirement for the sensing session. The RAN entity (e.g., BS) 106 configured to be or as a sensing also attempts to receive and measure signal transmitted by the RAN entity (e.g., BS) configured to be or as a sensing transmitter according to the received sensing configuration.

In step 10 (which may be omitted in some example embodiments), the RAN entity (e.g., BS) 105 configured to be or as a sensing transmitter role can transmit to the SeMF 103 information about updated sensing configuration, for instance due to local (RAN entity (e.g., BS)) decision and/or due to changes during the execution of step 9 at the RAN entity (e.g., BS) and/or due to changes at the sensing environment, conditions or measurements. Through this message, the RAN entity (e.g., BS) can provide the updated sensing configuration to the SeMF 103. Based on this message the SeMF 103 can update the respective sensing session, including any element that has been provided in step 5 above. The SeMF 103 may also transmit the updated configuration to the respective RAN entities (e.g., BS(s)).

The RAN entity (e.g., BS) configured to be or as a sensing transmitter can provide to the RAN entity(ies) (e.g., BS(s)) configured to be or as a sensing receiver the updated Sensing Configuration information.

In step 11, the RAN entity (e.g., BS) configured to be or as a sensing receiver role provides to the SeMF 103 the measurements of the conducted sensing operation (e.g., sensing data), identified by the sensing session ID and the BS ID.

In step 12, the SeMF 103, based on the received inputs from different RAN entities (e.g., BSs), processes the collected sensing measurements and determines the sensing output.

Steps 9 to 12 can be repeated or iterated, before sending sensing service response.

Step 13 is the same as the corresponding steps described above with reference to the message sequences 80 and 9o.

As another feature of this embodiment, the same RAN entity (e.g., BS) can be configured to be or as a sensing transmitter and sensing receiver for the same sensing session and/or for different sensing sessions.

It should be noted that multiple “Bi-static” and/or multi-static sensors (RAN entities) could be selected by the SeMF for the same sensing session. The SeMF should maintain, keep or store the list of the RAN entities involved to each sensing session (identified by the sensing session ID), the RAN entities selected role (sensing transmitter, sensing receiver), their context (e.g., sensing capabilities, sensing QoS) as well as the determined sensing session configuration and sensing resources configuration. For instance, SeMF may keep and/or maintain and/or store the following information:
Sensing Session ID
   Quality of service for the requested sensing service (Sensing QoS)
   List of RAN entities involved in the Sensing Session, including for each RAN entity one or more of the following information
      Sensor ID
      Sensing Method
      Sensing Capabilities of Sensor ID
      Sensing transmitter role
         BS ID
         Cell ID
         Tx Sensing Session Configuration of Sensor BS ID/Cell ID
         Tx Sensing Resources Configuration of Sensor BS ID/Cell ID
         Sensing Data Reporting configuration of transmitter Sensor BS ID(s)/Cell ID(s)
      Sensing receiver role
         BS ID(s)
         Cell ID(s)
         Rx Sensing Session Configuration of Sensor BS ID(s)/Cell ID(s)
         Rx Sensing Resources Configuration of Sensor BS ID(s)/Cell ID(s)
         Sensing Data Reporting configuration of Rx Sensor BS ID(s)/Cell ID(s)

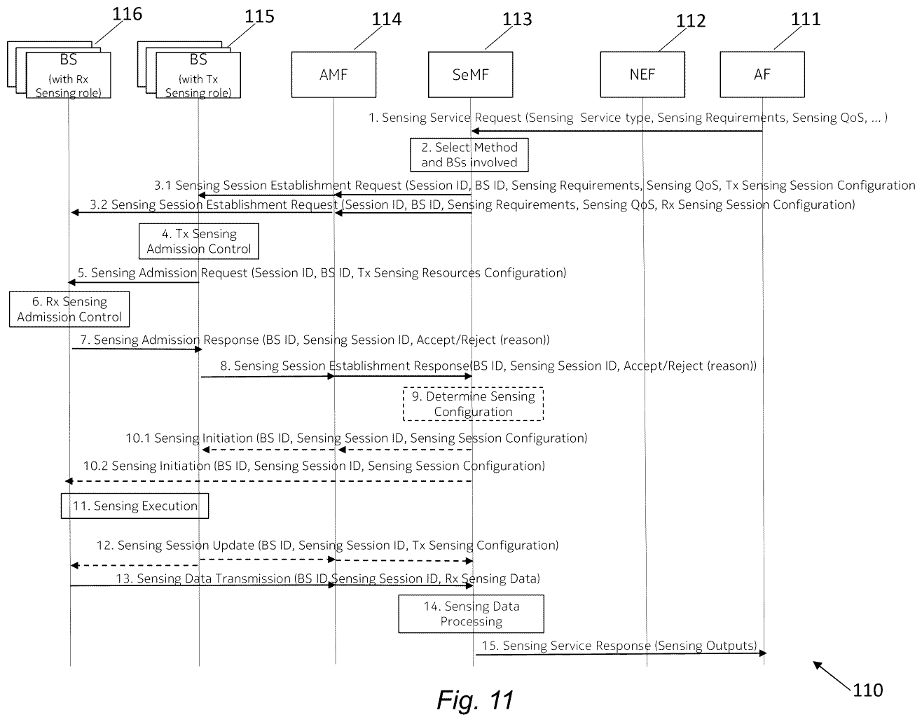

FIG. 11 shows a procedure, indicated generally by the reference numeral 110, in accordance with an example embodiment. The procedure 110 shows messages between an Application Function (AF) 111, a network exposure function (NEF) 112, a Sensing Management Function (SeMF) 113, an Access and Mobility Management Function (AMF) 114, and one or more first base stations (BS) 115 of a 5G wireless communication system that having a transmitter role, and one or more second base stations (BS) 116 of the 5G wireless communication system that have a receiver role. It should be noted, however, that the principles of the message sequence 110 could be applied to other communication systems.

The procedure 110 is an alternative to the procedure 100 described above. In the procedure 110, the RAN entity (e.g., BS) 115 is responsible for conducting the availability check of sensing resources, the selection of the necessary resources and configuring the respective sensing configurations. In this procedure, inter-RAN entity coordination is needed (e.g., via Xn or via the AMF) to support the coordination of RAN entities configured to be or as a sensing transmitter (e.g., having a sensing transmitter role and the RAN entities configured as sensing receivers (e.g., configured to be or as a sensing receiver.

Steps 1 and 2 are the same as the corresponding steps of the procedure 100 described above.

In step 3, the SeMF 113 sends a sensing session establishment request to the one or more RAN entities (e.g., BSs) (e.g. via the AMF 114) that are involved in the sensing operation, including one or more of the following:
the Sensing Session ID, generated by the SeMF to facilitate the coordination and handling of the sensing operations about the specific sensing service request
the BS ID, Cell ID
Sensing requirements (e.g., sensing area, duration, update rate)
Sensing QoS (e.g., sensing accuracy, sensing resolution, sensing delay)
Tx sensing session configuration and/or Rx sensing session configuration, depending on the identified role for each BS at step 2.

Sensing session configuration includes information about the selected sensing method and the role that each RAN entity (e.g., BS) has (e.g., is configured for). For example, information included in the sensing session configuration includes:
an identifier of a first RAN entity selected (e.g., Sensor ID #1)
   information indicating the sensing method the first RAN entity is selected to be involved in (e.g., monostatic sensing, bistatic sensing, or multi-static sensing)
   Sensing Area of the first RAN entity
   Timing information for the first RAN entity Sensor ID #1
   information indicating that the first RAN entity is configured for sensing transmitter role or as a sensing transmitter
   an identifier of the first RAN entity (e.g., BS ID)
   an identifier of a cell served by the first RAN entity (e.g., Cell ID)
   Information indicating the first RAN entity has a Sensing receiver role or is configured as a sensing receiver
an identifier of a second RAN entity (e.g., Sensor ID #2)
   Information indicating that the second RAN entity iSensing Method
   Sensing Area of Sensor ID #1
   Timing information of Sensor ID #1
   Sensing transmitter role
   BS ID
   Cell ID
   Sensing receiver role
   BS ID(s)
   Cell ID(s

The SeMF 113 can split sensing operations for a sensing session among different RAN entities, and also with different sensing configurations, if needed. Thus, different sensing session establishment requests may refer to different areas and/or focus on different sensing features.

In step 4, the RAN entity (e.g. BS) 115 that is configured to be or as a sensing transmitter, first checks whether it has the required resources to support (e.g., perform) the sensing operation for the sensing session according to the sensing requirements (e.g. duration, update rate) and required QoS for the sensing service (e.g., sensing accuracy, sensing resolution, sensing delay). The RAN entity (e.g., BS) 115 that is configured as a sensing transmitter then determines the transmitter resources that should be used for transmitting sensing signals by the RAN entity (transmitter sensing resource configuration).

The transmitter sensing resources configuration includes the resources that will be used for the sensing operation by the RAN entity (e.g., BS) involved in the sensing operation, including one or both of the following:
Option a) Pilots or Reference Signals that will be used for transmitting sensing signals
Option b) User plane and control plane resources that are to be used for transmitting sensing signals e.g., resource blocks, time or frequency resources, selected frequency band assigned for PDSCH to deliver control plane signal and/or user plane data.

According to the outputs of the admission control and resources availability check then the SeMF can return and repeat the step 2.

In step 5, the RAN entity (e.g., BS) 115 configured to be or as sensing transmitter transmits to the one or more RAN entities (e.g., BSs) 116 configured to be or as sensing receivers for the specific sensing session (identified by the sensing session ID or sensor ID) (as have been indicated in step 3) the determined transmitter sensing resource configuration i.e. sensing signal frequency, bandwidth, the timing when sensing signal is transmitted from RAN entity (e.g., BS).

For the RAN entity (e.g., BS) configured to be or as a sensing receiver, the RAN entity (e.g., BS) needs to know when (in the time domain) and where (in the frequency domain) the sensing signal is expected to be received. If the RAN entity (e.g., BS) configured to be or as a sensing receiver needs to receive multiple sensing signals from different RAN entities (e.g., BSs) configured to be or as sensing transmitters, the RAN entity (e.g., BS) configured to be or as a sensing receiver may need to know the information to distinguish the sensing signals (e.g. sensing signal attributes from each RAN entity (e.g., BS) configured to be or as a sensing transmitter).

In step 6, the RAN entity (e.g., BS) 116 configured to be or as a sensing receiver that has received the request to implement a sensing configuration and to check its availability of sensing resources (i.e. performs admission control).

In step 7, the RAN entity (e.g., BS) 116 configured to be or as a sensing receiver provides sensing admission response to the respective RAN entity (e.g., BS) 115 (i.e., that sent the request in step 5), indicating the success or failure to establish the requested sensing session (and may provide a cause code indicating a cause of the failure to establish the session session).

In step 8, the RAN entity (e.g., BS) 115 configured to be or as a sensing, according to its check and/or notifications from RAN entity(ies) (e.g., BS(s)) configured to be or as a sensing receiver, send a sensing session establishment response to the SeMF 113, indicating the success or failure to establish the requested sensing session and optionally a cause code indicative of a cause of the failure to establish the sensing session. Optionally, when the RAN entity (e.g, BS) 115 successfully establishes a sensing session, the RAN entity (e.g., BS) 115 also provides the sensing resource configuration and information to the RAN entities (e.g., BSs) selected by the SeMF 113 to be sensing receivers.

In optional step 9, the SeMF 113 can update the sensing session configuration according to the received responses.

In step 10 (which may be omitted in some example embodiments), the SeMF 113 informs the respective RAN entities (e.g., BSs) to initiate the sensing operations for the sensing session identified by the sensing session ID. This step may be needed, especially in the bi-static method, to ensure that RAN entities (e.g., BSs) 115 configured to be or as sensing with transmitters will not initiate sensing operation for the sensing session before the RAN entities (e.g., BSs) are configured to be sensing receivers based on the sensing configurations provided by the SeMF 113. Optionally, in case the SeMF 113 has differentiated the sensing session configuration, the later is included in the sensing initiation message.

The sensing data reporting configuration can be also provided to the RAN entities (e.g., BSs), which can be determined by the SeMF 113.

The steps 11 to 15 are the same as the corresponding steps presented in the procedure 110 (see steps 9 to 13 of that message sequence).

In another embodiment, if parts of step 3 of the procedure 110 (e.g., the session establishment request sent to the RAN entities selected to be configured to be sensing receives) is omitted, then the RAN entity (e.g., BS) configured to be or as a sensing 115 can optionally provide sensing session information, which may be required by the RAN entity (e.g., BS) selected to be configured to be or as a sensing receiver.

In another embodiment, the RAN entity (e.g., BS) configured to be or as a sensing transmitter can select the one or more RAN entities (e.g., BSs) to be configured to be a sensing receiver, in the case that this information is not provided by the SeMF and/or there is a need to update the sensing session. This is applicable to any other embodiment with multi-static sensing.

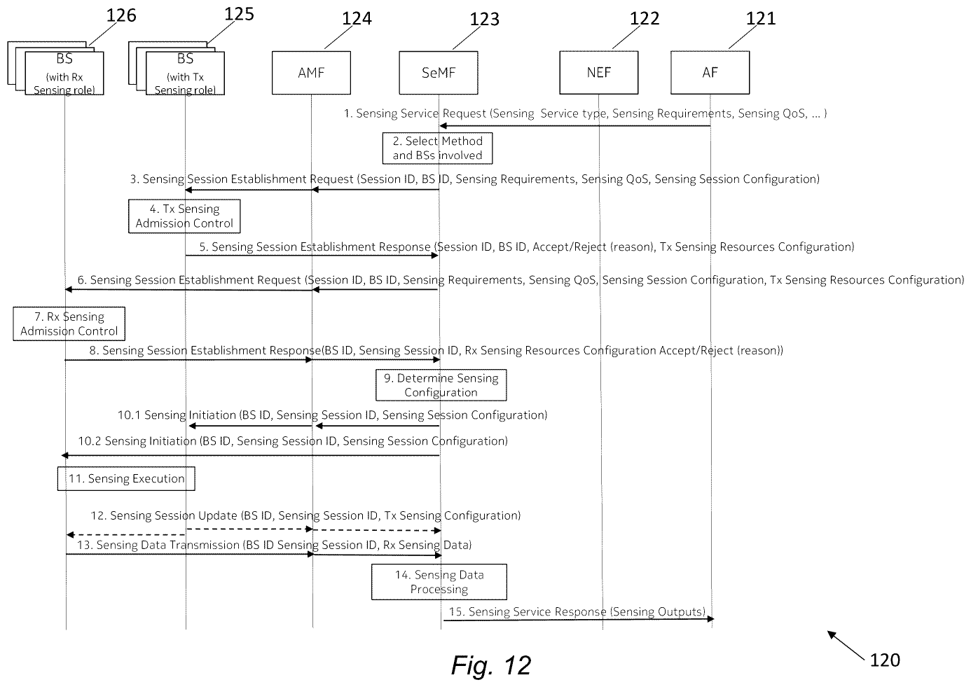

FIG. 12 shows a message sequence, and operations of a procedure indicated generally by the reference numeral 120, in accordance with an example embodiment. The procedure 120 shows messages (e.g. control plane messages) being sent between an Application Function (AF) 121, a network exposure function (NEF) 122, a Sensing Management Function (SeMF) 123, an Access and Mobility Management Function (AMF) 124, and one or more first base stations (BS) 125 of a 5G wireless communication system that having a transmitter role, and one or more second base stations (BS) 126 of the 5G wireless communication system that have a receiver role. It should be noted, however, that the principles of the message sequence 120 could be applied to other communication systems.

The procedure 120 differs from the procedure 110 described above in that the interaction among the BSs take place via the AMF(s) 124, instead of via the Xn interface.

Steps 1 to 4 of the procedure 120 are the same as steps 1 to 4 of the procedure 110.

In step 5, the RAN entity (e.g., BS) 125 that is configured to be or configured as a sensing transmitter transmits to the SeMF 123 a response to the sensing session establishment request (generally referred to as a sensing session establishment response) that includes an indication of acceptance or rejection of the sensing session establishment request that includes the specific Sensing Session ID and/or Sensor ID.

When the sensing session establishment response includes an indication of rejection of the sensing session establishment request, the response may also include a cause code indicative of a cause of the rejection of the sensing session establishment request. When the sensing session establishment response includes an indication of the sensing session establishment request an acceptance indication, the sensing resources configuration may be included in the response, as have been determined in step 4, considering:
Option a) Pilots or Reference signals that will be used for transmitting sensing signals or
Option b) User plane resources used for transmitting sensing signals.

According to the received response, the SeMF 123 may update the selected sensing method and/or selected new RAN entities (e.g., BSs) that are to be involved in the sensing session for the requested sensing service e.g., RAN entities that are to be configured to be sensing receivers.

In step 6, the SeMF 123 transmits (via the AMF 124) to the RAN entity (e.g., BS) 126 identified or selected to be a sensing receiver, a sensing session establishment request. The sensing session establishment request may include one or more of the following information:
Sensing Session ID
   Sensor ID
   BS ID
   Sensing Requirements (e.g., sensing area, duration, update rate)
   Sensing QoS (e.g., sensing accuracy, sensing resolution, sensing delay)
   Tx Sensing Resources Configuration (as determined in steps 4 and 5)
   Sensing Session Configuration, including information about selected method the role that each BS has. For instance:
   Sensor ID #1 . . . n
      Sensing Method
      Sensing Area of Sensor ID #1
      Timing information of Sensor ID #1
         Sensing Tx role
         BS ID
         Cell ID
         Sensing Rx role
         BS ID(s)
         Cell ID(s)

In step 7, the RAN entity (e.g., BS) 126 that has received the sensing session establishment request, implements or applies the sensing configuration and sensing resources configurations included in the sensing session establishment request, and optionally checks availability of the sensing resources.

For the RAN entity (e.g., BS) configured to be or as a sensing receiver, the RAN entity (e.g., BS) needs to know when (in the time domain) and where (in the frequency domain) the sensing signal is expected to receive. If RAN entity (e.g., BS) configured to be or as a sensing receiver needs to receive multiple sensing signals from different RAN entities (e.g., BSs) configured to be or as sensing transmitters, the RAN entity (e.g., BS) configured to be or as a sensing receiver may need to know the information to distinguish the multiple sensing signals (e.g. sensing signal attributes from each RAN entity (e.g., BS) configured to be or as a sensing transmitter).

In step 8, the RAN entity (e.g., BS) 126 configured to be or as a sensing receiver transmits to the SeMF 123 a sensing session establishment response, indicating the success or failure to establish the requested sensing session (and optionally a cause code indicating a cause of the failure cause to establish the sensing session). This response can also include the determined receiver sensing resources configuration.

In step 9, the SeMF 123 according to the received responses from RAN entities (e.g., BSs) configured as or to be a sensing receiver and/or sensing transmitter determines the respective sensing session configuration according to the received responses in step 5 and 8.

In step 10, the SeMF 123 informs the RAN entity (e.g., BS) configured to be or as a sensing transmitter or a sensing receiver sensing to initiate the sensing operations for the sensing session identified by the sensing session ID. The SeMF 123 includes in the sensing initiation message the sensing session configuration. The sensing data reporting configuration can be also provided to the RAN entities (e.g., BSs) configured to be or as a sensing transmitter and sensing receiver, which can be determined by the SeMF.

Steps 11 to 15 are the same as the corresponding steps in the procedures 100 and 110 discussed above.

The skilled person will be aware of many variants to the embodiments described herein. Some example variants are discussed briefly below.

In an example embodiment, the measurements of the conducted sensing operation (or sensing data) that are collected at the RAN entity (e.g., BS) configured to be or as a sensing receiver and provided by the RAN entity (e.g., BS) to the SeMF can include information about received sensing signal including information about power, delay, angles of departure and arrival, doppler shift of the sensing signals.

Optionally, in another embodiment, step 2 of the embodiments discussed above can take place at another entity e.g., AMF, RAN.

In an example embodiment, the procedures and signalling introduced above for the bi-static sensing method may also be applicable for a multi-static sensing method (e.g., sensing systems with multiple sensing receivers e.g., multiple RAN entities (e.g., BSs) configure to be or as sensing receivers.

In an example embodiment, combination of mono-static, bistatic and multi-static sensing methods could be used for the same sensing session. SeMF or RAN entity or any other NF may decide the combination of sensing methods that can be used for each sensing service and/or sensing operation.

In an example embodiment, when a sensing request is received by a SeMF, the SeMF may send a request to an AMF (or to another NF e.g., NRF or to a RAN entity or repository) to receive identifiers of one or more RAN entities (e.g., BSs) (e.g., in the form of a list of RAN entities (e.g. BSs) that includes the identifiers of the one or more RAN entities (e.g., BSs) that fulfil some selection criteria e.g., sensing requirements, sensing location etc. When the AMF or another entity provides the list of RAN entities (e.g., BSs), the SeMF may perform the final selection of the RAN entities (e.g. BSs) to be involved in a sensing session for a requested sensing service, and select each RAN entities (e.g., BSs) and identify their role (e.g., identify the RAN entity is to be configured as a sensing transmitter and/or a sensing receiver) based on the sensing method, and/or sensing configuration.

In an example embodiment, a RAN entity (e.g., BS) configured as a sensing transmitter can select the one or more RAN entities (BSs) configured as a sensing receiver to participate in the sensing operation and the RAN entity (e.g., BS) can provide the respective selected one or more RAN entities (e.g., BSs) their respective sensing configuration(s).

In an example embodiment, when a RAN entity (e.g., BS) conducts sensing admission control, the SeMF can transmit to the RAN entity, information (e.g., as part of the sensing session configuration) about the preferred sensing signal frequency, bandwidth, RAT etc that could facilitate the admission control procedure and/or resource allocation at the RAN entity (e.g., BS).

In an example embodiment, the admission control procedure performed by a RAN entity (e.g., BS) and/or by a SeMF may include privacy checks.

In an example embodiment, the sensing data may be sensing measurements (e.g., obtained by one or more RAN entities (e.g., BSs) configured to be or as a sensing receiver) and the sensing measurements can be transferred via the Xn interface to another RAN entity (e.g., BS configured to be or as sensing transmitter). The sensing measurements can then be provided by the another RAN entity to the SeMF or any other entity (e.g., at the RAN or core network or an application server) for processing to generate sensing output data.

In an example embodiment, some or all of the functionalities of the SeMF presented in the various embodiments described herein may be undertaken by the LMF.

In an example embodiment, a sensing session can be released by the SeMF transmitting to the RAN entities involved in a sensing session signalling or a message to release the sensing session.

In an example embodiment, a sensing session can be updated by the SeMF transmitting a sensing session update message to the RAN entities selected to be involved in a sensing session for the selected sensing method. The sensing session update message may include at least one of the following: new and/or updated session configuration, new and/or updated sensing resources configuration, new and/or updated sensing data reporting configuration, identifiers of RAN entities selected to be configured to be or as sensing transmitters and/or sensing receivers, or identifiers of RAN entities selected to be configured not be sensing transmitters and/or sensing receivers (e.g., identifiers or RAN entities that are to be removed as sensors). The updated sensing reporting configuration is updated based on the measurements reported by the RAN entities (e.g., BSs) and/or processing of sensing data.

In an example embodiment that more than one SeMF is involved in the same sensing service request, then the same Sensing Session ID may be used among the different SeMFs for all sensing configurations and/or reports that refer to the same sensing request (or sensing session).

In an example embodiment, the SeMF can invoke a service request (e.g., Sensing Session Establishment Request, Sensing Initiation etc) in an AMF and then the AMF may send the service request via an N2 interface. The service request may be sent by the SeMF to the AMF for all selected RAN entities (e.g., gNBs) and then the AMF would send separate N2 messages to each RAN entity (e.g., gNB). Alternatively, separate service requests may be sent by the SeMF for each selected RAN entity (e.g., gNB or any other BS).

In an example embodiment, the SeMF can directly communicate with each RAN entity selected to be involved in a sensing session.

In an example embodiment, the SeMF can be deployed in a RAN entity.

In an example embodiment the RAN entity may perform (e.g., conduct) a sensing operation and provide to the SeMF the sensing data (e.g., measurements) of the sensing operation using control plane resources or user plane resources.

The RAN entities (e.g., BSs) configured to be or as sensing transmitter or sensing receiver can be part of Standalone Non-Public Network (SNPN) and/or Public Land Mobile Network (PLMN) and/or Public Network integrated NPN.

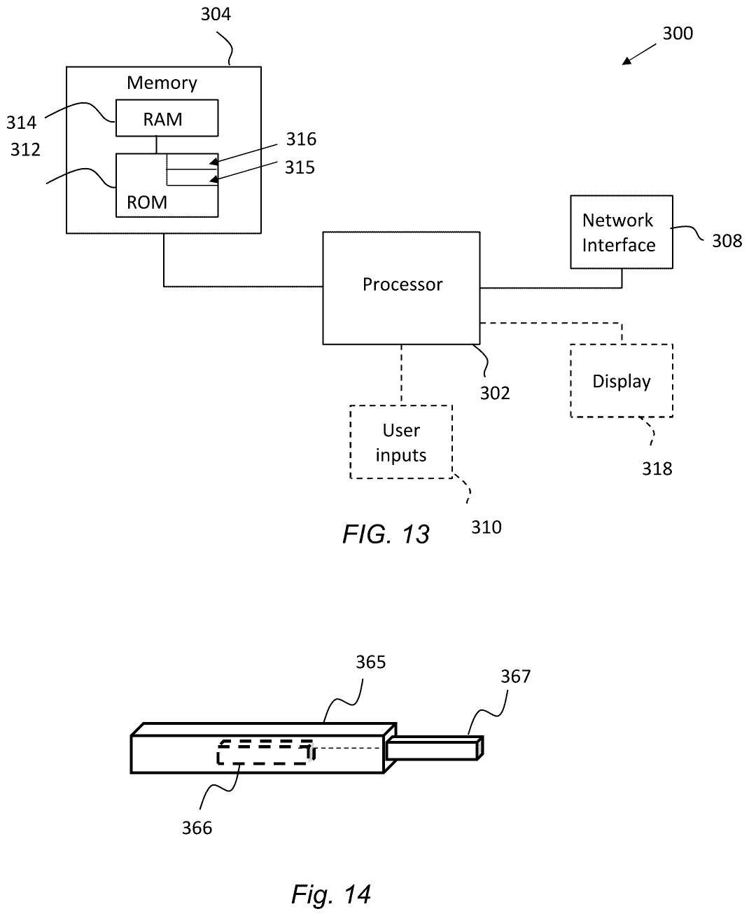

For completeness, FIG. 13 is a schematic diagram of components of one or more of the example embodiments described previously, which hereafter are referred to generically as a processing system 300. The processing system 300 may, for example, be the apparatus referred to in the claims below. For example, the processing system 300 may be used to implement functionality of a sensing management funtion (e.g., implemented by an SeMF), or features implemented at a sensing client or a RAN entity (e.g., base station) as discussed in detail above.

The processing system 300 may have a processor 302, a memory 304 closely coupled to the processor and comprised of a RAM 314 and a ROM 312, and, optionally, a user input 310 and a display 318. The processing system 300 may comprise one or more network or apparatus interfaces 308 for connection to a network or apparatus, e.g., a modem which may be wired or wireless. The network or apparatus interface 308 may also operate as a connection to other apparatus such as device or apparatus which is not network side apparatus. Thus, direct connection between devices or apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the methods, processes and sequences 40, 50, 60, 70, 80, 90, 100, 110 and 120 described above. Note that in the case of small device or apparatus the memory can be most suitable for small size usage i.e., not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e., embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIG. 14 shows a tangible media, in the form of a removable memory unit 365, storing computer-readable code which when run by a computer may perform methods according to example embodiments described above. The removable memory unit 365 may be a memory stick, e.g. a USB memory stick, having internal memory 366 storing the computer-readable code.

The internal memory 366 may be accessed by a computer system via a connector 367. Of course, other forms of tangible storage media may be used, as will be readily apparent to those of ordinary skilled in the art. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and sequences of FIGS. 4 to 12 are examples only and that various operations depicted therein may be omitted, reordered and/or combined.

It will be appreciated that the above-described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus comprising:
at least one processor; and
at least one memory storing instructions of a sensing management function, wherein execution of the instructions causes the apparatus to perform at least:
receiving, from a sensing client of a wireless communication system, a sensing service request including information related to a sensing service, requested by the sensing client, to be provided by the sensing management function;
selecting, based, at least in part, on the information related to the sensing service, one of: monostatic sensing for the sensing service, in which a first selected radio access network node is used for transmission and reception of radio signals used for sensing, and multi-static sensing, in which one selected radio access network node is used for transmission of radio signals for sensing and one or more other selected radio access nodes are used for reception of radio signals used for sensing;
based on monostatic sensing being selected: sending, to the first selected radio access network node used for transmission and reception of radio signals used for sensing, a sensing configuration for the first selected radio access network node; and
based on multi-static sensing being selected: sending, to the one selected radio access network node used for transmission of radio signals used for sensing, a sensing configuration for the one selected radio access network node.

2. The apparatus of claim 1, wherein the sensing configuration for the first selected radio access network node used for transmission and reception of radio signals used for sensing comprises at least one of a sensing resource configuration, a sensing session configuration, and a sensing data reporting configuration.

3. The apparatus of claim 1, wherein the sensing configuration for the one selected radio access network node used for transmission of radio signals for sensing comprises at least one of a sensing resource configuration, a sensing session configuration, and a sensing data reporting configuration.

4. The apparatus of claim 1, wherein, based on multi-static sensing being selected, execution of the instructions further causes the apparatus to perform at least:
sending, to each respective other radio access network nodes used for reception of radio signals, a sensing configuration for the respective other radio access network node.

5. The apparatus of claim 4, wherein the sensing configuration for each respective other radio access network node comprises at least one of a sensing resource configuration, a sensing session configuration, and a sensing data reporting configuration.

6. The apparatus of claim 1, wherein the information related to said sensing service comprises at least one of: a sensing service type for the sensing service; sensing requirements for the sensing service; and sensing quality of service for the sensing service.

7. The apparatus of claim 6, wherein the sensing requirements for the sensing service include a sensing area for the sensing service.

8. The apparatus of claim 1, wherein sending the sensing configuration for the first selected radio access network node comprises sending, to the first selected radio access network node, a request to establish a sensing session for the sensing service that includes the sensing configuration for the first selected radio access network node.

9. The apparatus of claim 1, wherein execution of the instructions further causes the apparatus to perform at least:
sending, to the first selected radio access network node used for transmission and reception of radio signals for sensing, a request for the radio access network node to initiate sensing.

10. The apparatus of claim 1, wherein execution of the instructions further causes the apparatus to perform at least one of:
receiving sensing data from the first selected radio access network node used for transmission and reception of radio signals for sensing; and
receiving sensing data from the one or more other selected radio access network nodes used for reception of radio signals used for sensing.

11. The apparatus of claim 10, wherein execution of the instructions further causes the apparatus to perform:
processing the sensing data to generate sensing output data; and
providing the sensing output data.

12. The apparatus of claim 1, wherein, sending the sensing configuration for the one selected radio access network node comprises sending, to the one selected radio access network node, a request to establish a sensing session for the sensing service that includes the sensing configuration for the one selected radio access network node.

13. The apparatus of claim 12, wherein the request further includes an indication that the one selected radio access network nodes initiate sensing.

14. The apparatus of claim 1, wherein execution of the instructions further causes the apparatus to perform at least:
controlling session admission in which a determination is made regarding whether respective selected network node(s) are able to meet the defined requirements.

15. An apparatus comprising:
at least one processor; and
at least one memory storing instructions for a sensing management function, wherein execution of the instructions causes the apparatus to perform at least:
receiving a sensing configuration for a sensing service at a radio access network node of a wireless communication system from a sensing management function of the wireless communication system, wherein the sensing configuration configures at least one of monostatic sensing for the sensing service, in which the radio access network node is a first selected radio access network node used for transmission and reception of radio signals used for sensing, and multi-static sensing, in which the radio access network node is one selected radio access network node used for transmission of radio signals for sensing or one of one or more other selected radio access nodes used for reception of radio signals used for sensing;
configuring the radio access node in accordance with said sensing configuration; and
causing the radio access network node to initiate sensing.

16. The apparatus of claim 15, wherein execution of the instructions further causes the apparatus to perform at least one of:
transmission of radio signals for sensing; and
reception of radio signals for sensing.

17. The apparatus of claim 15, wherein execution of the instructions further causes the apparatus to perform at least one of:
providing received radio signals to the sensing management function; and
processing received radio signals and providing the processed received radio signals to the sensing management function.

18. The apparatus of claim 15, wherein execution of the instructions further causes the apparatus to perform at least:
receiving a request for the radio access network node to initiate sensing.

19. The apparatus of claim 15, wherein execution of the instructions further causes the apparatus to perform:
controlling session admission in which a determination is made regarding whether sufficient resources are available to meet the sensing requirements defined in the session establishment messages.

20. The apparatus of claim 15, wherein execution of the instructions further causes the apparatus to perform at least one of:
providing a sensing session establishment response in response to a request to establish a sensing session; or
sending information about an updated sensing configuration.
